(19) United States
(12) Patent Application Publication
(10) Pub. No.: US 2006/0023299 A1
(43) Pub. Date: Feb. 2, 2006

(54) Biological sample observation system and biological sample observation method

(75) Inventor: Kayuri Muraki, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: Olympus Corporation, Tokyo (JP)

(21) Appl. No.: 11/153,786

(22) Filed: Jun. 15, 2005

(30) Foreign Application Priority Data
Jun. 17, 2004 (JP) 2004-180150
Jun. 8, 2005 (JP) 2005-168467

(51) Int. Cl. G02B 21/00

(52) U.S. Cl. 359/368

(57) ABSTRACT

A biological sample observation system wherein the fluorescence intensity of living cells and the like can be measured accurately in real time, and damage to the living cells can be reduced, and a biological sample observation method using the system are provided. A biological sample observation system for observing change with time in a biological sample being cultured, comprises: a culturing space where an inside environment is maintained at a predetermined level, and the biological sample is cultured under the environment; a buffering space which is formed outside of the culturing space to relieve the effect on the culturing space from the outside of the space, and which is substantially separated from the outside; and a detector which observes the biological sample inside the culturing space through at least a part of the buffering space.

### BACKGROUND OF THE INVENTION

1. Field of the Invention

The present invention relates to a biological sample observation system wherein a biological sample is cultured while it is observed with the passage of time, and to a biological sample observation method which uses the system.

This application is based on Japanese Patent Application No. 2004-180150, the content of which is incorporated herein by reference.

2. Description of Related Art

With the progress of recent genetic analysis technology, the gene sequences of many living things including humans have been revealed, and the causal relationship between diseases and the analyzed gene products such as proteins is starting to be elucidated little by little. Moreover, in order to comprehensively and statistically analyze various proteins and genes furthermore in the future, consideration is starting to be given to various testing methods and devices using biological samples, in particular cells.

Normally, cells are disseminated in a dish, a flask, or the like made from plastic or glass, and cultured in an incubator. The environment inside the incubator is kept suitable for culturing cells, by setting for example the carbon dioxide concentration to 5%, the temperature to 37° C., and the humidity to 100%.

Furthermore, the culture solution in the incubator is exchanged every two to three days, so as to provide the cells with nutrition, and maintain a suitable pH for culturing.

As a method of observing such cells while they are being cultured, several methods are known. Among these is known a method where the dish or the flask is taken our from the incubator, and the observation is performed using an inverted type microscope such as a phase-contrast microscope.

In such a method, it is necessary to observe the cells as quickly as possible, and to put the cells back into the incubator after the observation. This is to prevent damage to the cell activity caused by a normal environment (environment different from the environment suitable for culturing) under which the cells are held for a long time.

That is to say, if the cell activity is unstable, accurate evaluation becomes difficult to perform. Moreover, when the cells are taken out from the incubator, good care should be taken not to cause contamination and the like.

Furthermore, as another cell observation method, there is known a method where a transparent constant temperature incubator for microscopy, capable of setting various cell culture conditions is used (refer to Japanese Unexamined Patent Application, First Publication No. 10-28576 (FIG. 3 and the like)).

However, in the observation using the abovementioned inverted type microscope, cells must be taken out from the incubator at each time of the observation. Therefore, the position for observing the cells differs when the cells are taken-out and put back in, and it has been difficult to observe the same cell group at each time.

The transparent constant temperature incubator for microscopy disclosed in Japanese Unexamined Patent Application, First Publication No. 10-28576 (FIG. 3 and the like) schematically comprises a pair of transparent exothermic plates of which the temperatures can be controlled to predetermined temperatures by a temperature controller, an airtight container having a carbon dioxide supply port and an exhaust port for adjusting the carbon dioxide concentration, and an evaporating dish for maintaining the humidity in the airtight container.

Therefore, by using the transparent constant temperature incubator for microscopy, the temperature, the carbon dioxide concentration, and the humidity inside of the container can be controlled, and it has been possible to observe the cells while they are being cultured. That is, for example, by observing from the bottom of the transparent exothermic plate, the change with time in the culture state of the cells can be continuously and readily observed and recorded.

In the observation using the transparent constant temperature incubator for microscopy, since the positions of the cells are displaced if the culture solution in the container is exchanged, it has been difficult to observe the same cell group at each time.

That is, in this method, it is possible to observe the cell culture during about every other day or more when the exchange of culture solution is not required. However it has been difficult to trace the same cell if the cell culture is performed for a longer period.

As yet another cell observation method, there is known a method where cells in difference dishes are evaluated in each measurement. This is a method wherein, in the case where a change with time of cells is detected, a large number of dishes having the cells disseminated in the same condition, are prepared, and the respective dishes are taken out from the incubator at each predetermined measuring time for evaluation.

In this method, cells in one or several dishes are used for a single observation, and there has been concern of damage to the activity of the cells due to a variety of operations for observation. Therefore, one dish is used for a single observation only, that is, the cells which have been once measured are disposed of.

As described above, in the method where cells in different dishes are evaluated in each measurement, since the respective dishes do not always have completely the same conditions, it has been unreasonable to assume that the cell groups in different dishes belong to the same cell group, in performing observation.

In particular, since cells have different expressions of protein and the like depending on the cell cycle, the measurement has had to be performed after combining the cell cycles according to the object to be evaluated. However, the cell cycles of different cells are matched for only about 2 cycles at most, and the lag becomes greater as the cycles are repeated thereafter. Therefore, there has been the inconvenience of limiting the experimental protocol.

As described above, since environmental factors strongly affect the cell activity, it has been difficult to observe the same cell group under the microscope at all times. Therefore, in order to observe it at all times, there is considered a method of using, for example, a microscope of a type where the environment of temperature and humidity is maintained by covering the overall microscope with a box or the like.

However, in this case, since in an environment without carbon dioxide, it is difficult to keep the optimum pH for culture, the cell activity can only be maintained for about several hours.

Moreover, it is also considered to introduce carbon dioxide under a highly humid environment. However, in this case, there has been concern of damage to the life of the very expensive microscope due to corrosion.

Furthermore, depending on the cell type, there is also a species that is very vulnerable to changes in the external environment, so that there is concern of extinction easily caused by a rapid temperature-increasing operation, or a deviated temperature distribution, for example. Specifically, although depending on the cell type, it has been generally necessary to maintain a constant range of temperature at 37° C.±0.5° C., and of carbon dioxide concentration at 3% to 8%.

Furthermore, when a plurality of cells are observed, there is know a technique wherein a dish having the cells disseminated is stored in an incubator box and held on a stage, so as to observe the plurality of cells by moving the cells using the stage. In such a stage transfer mechanism, a magnet and an electromagnet are often used for a drive motor and the like. Moreover, in some cases a magnet is used to fix a cover of the incubator box for containing the dish. Therefore, weak electricity, static electricity, magnetism, and the like may be generated by the magnet and the electromagnet in the incubator box.

At this time, if the biological sample used for culture and observation is very sensitive to stimulation as with cells, in particular, infantile cells and the like, and if it is contained in the incubator box as is, then the electricity, static electricity, or magnetism affect the biological sample. Therefore there has been a problem of a difficulty in obtaining an accurate observation result.

Specifically, a cell transfers substances from/to the outside through the cell membrane, and the transfer of substances is regulated by a small amount of electricity. If cells are affected by the weak electricity or magnetism as described above, the regulation of the cell membrane is changed, causing a change in the cell activity, and there has been concern of a deviation in the measured value.

Moreover, there has been concern of shortening the culturable time of the cells since the cell activity is changed.

### BRIEF SUMMARY OF THE INVENTION

The present invention was achieved in order to solve the above problems, with an object of providing a biological sample observation system wherein the fluorescence intensity of living cells and the like can be measured accurately in real time, and damage to the living cells can be reduced, and a biological sample observation method using the system.

In order to achieve the above object, the present invention provides the following means.

One aspect of the present invention is a biological sample observation system for observing change with time in a biological sample being cultured, comprising: a culturing space where an inside environment is maintained at a predetermined level, and the biological sample is cultured under the environment; a buffering space which is formed outside of the culturing space to relieve an effect on the culturing space, from the outside of the culturing space, and which is substantially separated from the outside; and a detector which observes the biological sample inside the culturing space through at least one part of the buffering space.

Another aspect of the present invention is a biological sample observation method for observing a change with time in a biological sample being cultured, comprising: a step for providing a culturing space where the inside environment is maintained at a predetermined level, and the biological sample is cultured under the environment; a step for providing a buffering space which is formed outside of the culturing space to relieve the effect on the culturing space from the outside of the culturing space, and which is substantially separated from the outside; a step for culturing the biological sample in the culturing space; and a step for observing the biological sample inside the culturing space through at least one part of the buffering space, using a detector which observes the biological sample.

### BRIEF DESCRIPTION OF THE SEVERAL VIEWS OF THE DRAWINGS

FIG. 1 is a perspective view showing a biological sample observation system according to a first embodiment of the present invention.

FIG. 2 is a schematic diagram showing the system structure of the biological sample observation system of FIG. 1.

FIG. 3 is a perspective view showing an incubator box of FIG. 1.

FIG. 4 is a cross-sectional view of a chamber of FIG. 3.

FIG. 5A is a perspective view showing another example of the incubator box of FIG. 1.

FIG. 5B is a perspective view showing yet another example of the incubator box of FIG. 1.

FIG. 6A shows an example of a selected example of a scan method and a detection range in the present embodiment.

FIG. 6B shows another example of a selected example of the scan method and the detection range in the present embodiment.

FIG. 6C shows yet another example of a selected example of the scan method and the detection range in the present embodiment.

FIG. 6D shows yet another example of a selected example of the scan method and the detection range in the present embodiment.

FIG. 7 is a flowchart showing the flow of measurement parameter setting in the present embodiment.

FIG. 8A is a flowchart showing the flow of measurement in the present embodiment.

FIG. 8B is a flowchart showing the flow of measurement in the present embodiment.

FIG. 8C is a flowchart showing the flow of measurement in the present embodiment.

FIG. 9 is a flowchart showing an image processing method in the present embodiment.

FIG. 10 is a flowchart showing the flow of data processing in the present embodiment.

FIG. 11 is a flowchart showing the flow of light quantity adjustment in the present embodiment.

FIG. 12 is a flowchart showing a supplying/exchanging method of a culture solution in the present embodiment.

FIG. 13 shows a tracked image of cells, showing the change of cells with the passage of time in the present embodiment.

FIG. 14A is a flowchart showing culture and measurement using a microplate of the present embodiment.

FIG. 14B is a flowchart showing culture and measurement using the microplate of the present embodiment.

FIG. 15A is a front view showing a biological sample observation system according to a second embodiment of the present invention.

FIG. 15B is a side view showing the biological sample observation system according to the second embodiment of the present invention.

FIG. 16 is a plan view of a culturing stage of FIG. 15A.

FIG. 17 is a perspective view of the culturing stage of FIG. 15A.

### DETAILED DESCRIPTION OF THE INVENTION

[First Embodiment]

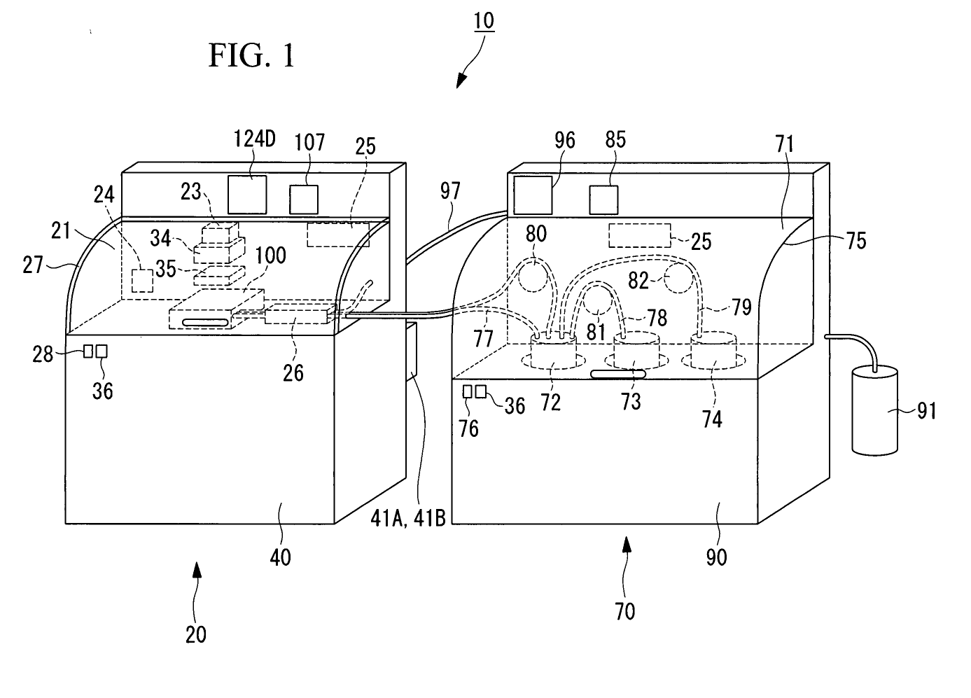

Hereunder is a description of a biological sample observation system according to a first embodiment of the present invention, with reference to FIG. 1 to FIG. 14B.

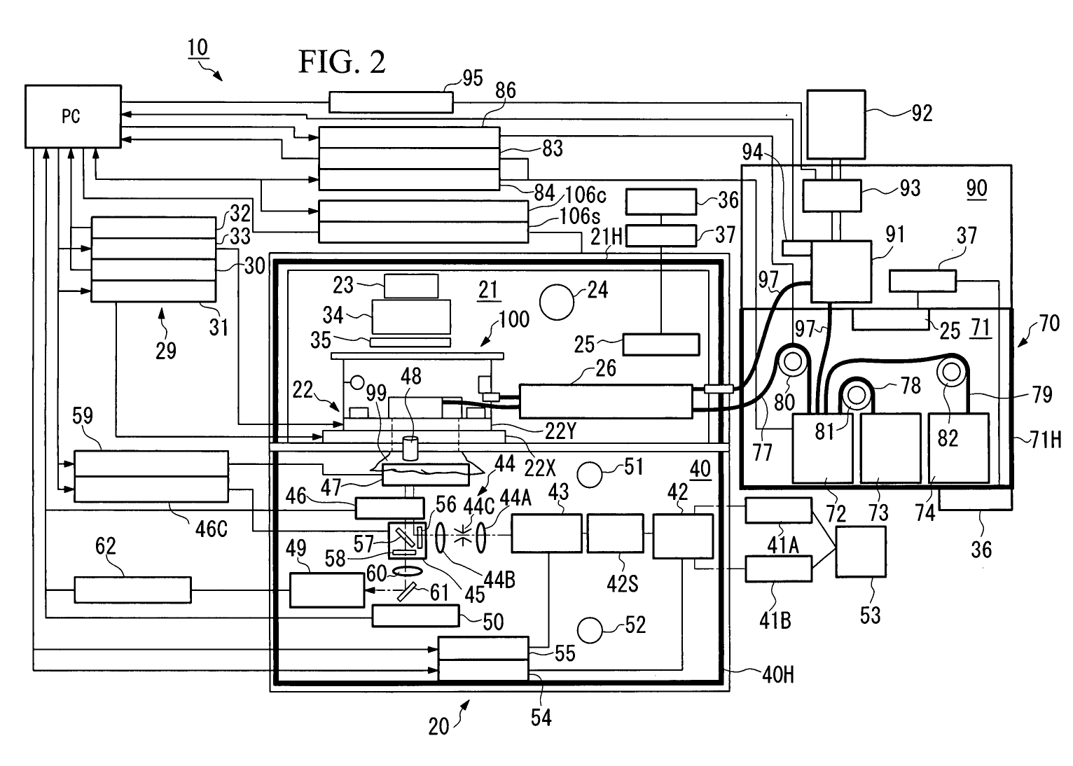

FIG. 1 is a perspective view showing the outline of the biological sample observation system according to the present embodiment. FIG. 2 is a schematic diagram showing the system structure of the biological sample observation system thereof.

As shown in FIG. 1 and FIG. 2, a biological sample observation system 10 schematically comprises a detection unit 20, and a culturing unit 70. The detection unit 20 and the culturing unit 70 are desirably arranged close to each other. More preferably, these units 20 and 70 are arranged in contact with each other.

As shown in FIG. 1 and FIG. 2, the detection unit 20 schematically comprises a heat-insulating box (first zone) 21 for containing a biological sample inside, and a detection section (observation device, second zone) 40 which measures the cells (biological sample) CE.

The heat insulating box 21 comprises; a heater 21H which keeps the inside of the heat insulating box 21 warm at a predetermined temperature, a stage (movable stage) 22 which holds an incubator box (culturing space, second space, first zone) 100 described later, a transmitted light source 23 which irradiates light to the cells CE, a fan 24 which makes uniform the temperature inside of the heat insulating box 21, a UV lamp 25 which sterilizes the inside of the heat insulating box 21, a carrier 26 which protects a culture solution circulation pipeline 77 and a culture gas supply pipeline 97 described later, an openable and closable cover 27 which is used for putting in and taking out the incubator box 100 or the like from the heat insulating box 21, and a main power switch 28 which turns ON/OFF the main power source of the detection unit 20.

The stage 22 has an X axis operation stage (movable stage) 22X and a Y axis operation stage (movable stage) 22Y which are relatively moved in mutually orthogonal directions, and scanning is controlled by a stage scanning section 29.

The stage scanning section 29 comprises; an X axis coordinate detection section 30 which detects the X axis coordinate value of the X axis operation stage 22X, an X axis scanning control section 31 which controls the operation (scan) of the X axis operation stage 22X, a Y axis coordinate detection section 32 which detects the Y axis coordinate value of the Y axis operation stage 22Y, and a Y axis scanning control section 33 which controls the operation (scan) of the Y axis operation stage 22Y.

The X axis coordinate detection section 30 and the Y axis coordinate detection section 32 are arranged to respectively output the detected X coordinate of the X axis operation stage 22X and Y coordinate of the Y axis operation stage 22Y to a computer PC. The X axis scanning control section 31 and the Y axis scanning control section 33 are arranged to respectively control the scan of the X axis operation stage 22X and the scan of the Y axis operation stage 22Y, based on the instructions from the computer PC.

An example of a mechanism which drives the X axis operation stage 22X and the Y axis operation stage 22Y includes for example a combination of a motor and a ball screw.

The computer PC (analysis device) also controls the detection system of the cells CE, and analyzes the captured image of the cells CE as described later, as well as controlling the scan of the X axis operation stage 22X and the scan of the Y axis operation stage 22Y as described above. The X axis operation stage 22X, the Y axis operation stage 22Y, the detection system, and the analysis system, are controlled linked together.

A condenser lens 34 which focuses the light emitting from the transmission light source 23 onto the cells CE, is arranged between the transmission light source 23 and the incubator box 100.

A shutter 35 may be provided between the condenser lens 34 and the incubator box 100, or the shutter 35 may not be provided.

The fan 24 is arranged on the wall surface of the heat insulating box 21. By operating the fan 24, the air in the heat insulating box 21 is convected so that the temperature in the heat insulating box 21 can be readily kept uniform and constant.

The UV lamp 25 is connected to a UV lamp switch 36 arranged on the wall surface of the detection unit 20. A timer which controls the operation of the UV lamp 25 timewise is arranged between the UV lamp 25 and the UV lamp switch 36. Furthermore, there is arranged a sterilization indicator lamp (not shown) which indicates if the UV lamp 25 is turned on.

For example, if the UV lamp switch 36 is pressed when the cells CE are not being measured, the counting of the timer 37 is started and the power is supplied to the UV lamp 25, and UV light (ultraviolet light) is irradiated into the heat insulating box 21. At the same time, the sterilization indicator lamp is also turned on. Then, after a predetermined time (for example, 30 minutes) has passed and the counting of the timer 37 is terminated, the timer 37 stops the power supply to the UV lamp 25 to terminate the irradiation of UV light. Moreover, the sterilization indicator lamp is also turned off.

The UV lamp 25 is controlled separately from the main power switch 28, and can be operated even if the main power source is turned off.

The lighting time of the UV lamp 25 may be 30 minutes as mentioned above, or may be less than 30 minutes or longer than 30 minutes as long as the time allows the various bacteria in the heat insulating box 21 to be completely killed.

The openable and closable cover 27 is made from a metal such as an alumite coated aluminum, or a semitransparent resin having a high shading property. The structure of the openable and closable cover 27 is considered to be a hollow dual structure, and furthermore a structure having the aforementioned metal for the inside and resin for the outside.

By using the resin for the outside of the openable and closable cover 27, the heat in the heat insulating box 21 can be kept from escaping from the openable and closable cover 27 to the outside. Moreover, using the alumite coated metal for the inside of the openable and closable cover 27, deterioration in the lifetime of the openable and closable cover 27 due to the UV lamp 25 can be avoided.

If the openable and closable cover 27 has the dual structure of a metal or a metal and a resin, it is completely shaded. Therefore a peephole is desirably provided in a position to enable peeping into the incubator box 100. Desirably a transparent resin or a glass is fitted into the peephole, and an openable and closable cover is arranged on the outside.

As shown in FIG. 1 and FIG. 2, the detection section 40 comprises; a heater 40H which keeps the inside of the detection section 40 warm at a predetermined temperature, incident light sources 41A and 41B which irradiate the cells CE from the detection section 40 side, an optical path switch section 42 which switches the optical paths from the incident light sources 41A and 41B, a light quantity adjustment mechanism 43 which adjusts the light quantity of the irradiation light, a lens system 44 which focuses the irradiation light towards the cells CE, a filter unit 45 which controls the wavelength of the irradiation light and the wavelength of the detection light, an autofocus (AF) unit 46 which performs the focusing operation on the cells CE, a revolver 47 comprising object lenses 48 having a plurality of magnifications and different properties, a detector 49 which detects the detection light from the cells CE, a light quantity monitor 50 which measures the light quantity of the detection light, a fan 51 which makes uniform the temperature inside of the detection section 40, and a cooling fan 52 which cools the inside of the detection section 40.

The incident light sources 41A and 41B comprise for example mercury lamps or the like, and are arranged outside of the detection section 40, and are respectively connected to a power source 53 which supplies their power.

Moreover, normally one incident light source, for example the incident light source 41A is used. However, if the light quantity of the incident light source 41A drops below a predetermined prescribed value, the illuminating light is irradiated from the incident light source 41B, and the power source of the incident light source 41A is turned off.

The optical path switch section 42 is formed to lead either one of the illuminating light from the incident light source 41A or the illuminating light from the incident light source 41B to the light quantity adjustment mechanism 43. Moreover in the optical path switch section 42 there is arranged an optical path control section 54 which is connected to the computer PC described later to control the optical path switch section 42, based on an instruction from the computer PC.

A shutter 42S is arranged on the illuminating light emission side of the optical path switch section 42, so as to perform transmission/shutdown control of the illuminating light.

A light quantity adjustment mechanism 43 is arranged on the illuminating light emission side of the shutter 42S, so as to adjust the light quantity of the illuminating light transmitted through the shutter 42S. As the mechanism, a well-known aperture mechanism may be used, or some other well-known mechanism and technique that can adjust the light quantity may be used.

Moreover, in the light quantity adjustment mechanism 43 there is arranged a light quantity control section 55 which is connected to the computer PC described later to control the light quantity adjustment mechanism 43 based on an instruction from the computer PC.

A lens system 44 is arranged on the illuminating light emission side of the light quantity adjustment mechanism 43. The lens system 44 comprises a pair of lenses 44A and 44B, and an aperture 44C arranged between the lens 44A and the lens 44B.

The filter unit 45 comprises an excitation filter 56, a dichroic mirror 57, and an absorption filter 58. The excitation filter 56 is one which passes light (exciting light) having a wavelength that contributes to the fluorescence of the cells CE, among the illuminating light, and is arranged so that the illuminating light emitting from the lens system 44 is incident into the excitation filter 56. The dichroic mirror 57 is an optical element that separates exciting light and fluorescent light. The dichroic mirror 57 is arranged so that the exciting light transmitted through the excitation filter 56 is reflected towards the cells CE, and the fluorescent light from the cells CE is transmitted. The absorption filter 58 is an optical element that separates fluorescent light from the cells CE, and the other unnecessary scattered light, and is arranged so that the light transmitted through the dichroic mirror 57 is incident thereinto.

A filter control section 46C which controls the wavelength of the exciting light or the detection light (fluorescent light) emitting from the filter unit 45 based on an instruction from the computer PC described later, is arranged in the filter unit 45.

One of each excitation filter 56, dichroic mirror 57, and absorption filter 58 may be used, or a plurality of them may be used.

The AF unit 46 is arranged on the exciting light emission side of the filter unit 45, so that the exciting light is focussed onto the cells CE through the object lens 48, based on the instruction from the computer PC described later.

The revolver 47 is arranged on the exciting light emission side of the AF unit 46, and is arranged with a plurality of object lenses 48 having a plurality of magnifications. On the revolver 47, there is arranged an object lens control section 59 which selects and controls the object lens 48 into which the exciting light is incident, based on the instruction from the computer PC described later.

The object lens 48 has a structure where the inside of the incubator box in the heat insulating box 21 can be observed from the detection section 40 through holes respectively provided in the X axis operation stage 22X and the Y axis operation stage 22Y.

For the X axis operation stage 22X and the Y axis operation stage 22Y, the size of the holes includes some leeway to allow for a range wherein the stage is operated.

Therefore, even though the atmosphere in the heat insulating box 21 is kept at a temperature suitable for the cell culture, the atmosphere escapes through the holes to the detection section 40, so the temperature suitable for the cell culture can not be maintained, causing the likelihood that the cell activity is decreased.

Here, there may be provided a restraining device 99 (restraining section) which restrains such an atmosphere at the temperature suitable for the cell culture, from passing through between the heat insulating box 21 and the detection section 40.

The restraining device 99 may be any form as long as the movement of the revolver 47 and the object lenses 48 are not interrupted. For example, it is considered to be in film form having a sheet made from a soft material such as a film or a transparent sheet adhered around the hole provided on the border between the heat insulating box 21 and the detection section 40, and attached so as to hang down around the revolver.

A condenser lens 60 which collects the detection light onto the detector 49 and the light quantity monitor 50, is arranged on the detection light emission side of the filter unit 45.

A half mirror 61 which reflects a part of the detection light towards the detector 49 and lets the rest of the detection light pass through towards the light quantity monitor 50, is arranged on the detection light emission side of the condenser lens 60.

The detector (imaging device) 49 is arranged in a position into which the detection light reflected from the half mirror 61 is incident. Moreover, a detector calculation section 62 which calculates the detection signal from the detector 49 and outputs it to the computer PC described later, is connected to the detector 49.

The detector 49 is not specifically limited, and for example a line sensor may be used, an area sensor may be used, or the line sensor and the area sensor may be used together.

The light quantity monitor 50 is arranged to measure the detection light transmitted through the half mirror 61, and output the measured value to the computer PC.

As described above, the light quantity of the detection light may be measured using the light quantity monitor 50, or the light quantity of the detection light may be measured using an illuminometer, a power meter, or the like.

The heater 40H controls the temperature of the inside of the detection section 40 to keep it warm at 30° C. to 37° C., for example. The fan 51 is arranged to convect the air in the detection section 40 so that the temperature in the detection section 40 becomes uniform. Therefore, the temperature in the detection section 40 can be kept at a temperature close to that of the heat insulating box 21, so that the temperature of the heat insulating box 21 can be stabilized more readily.

The cooling fan 52 is driven to decrease the temperature in the detection section 40, based on the output from the temperature sensor (not shown) that is arranged in the detection section 40. Therefore, an abnormal increase in the temperature in the detection section 40 due to the heating of a motor or the like can be prevented.

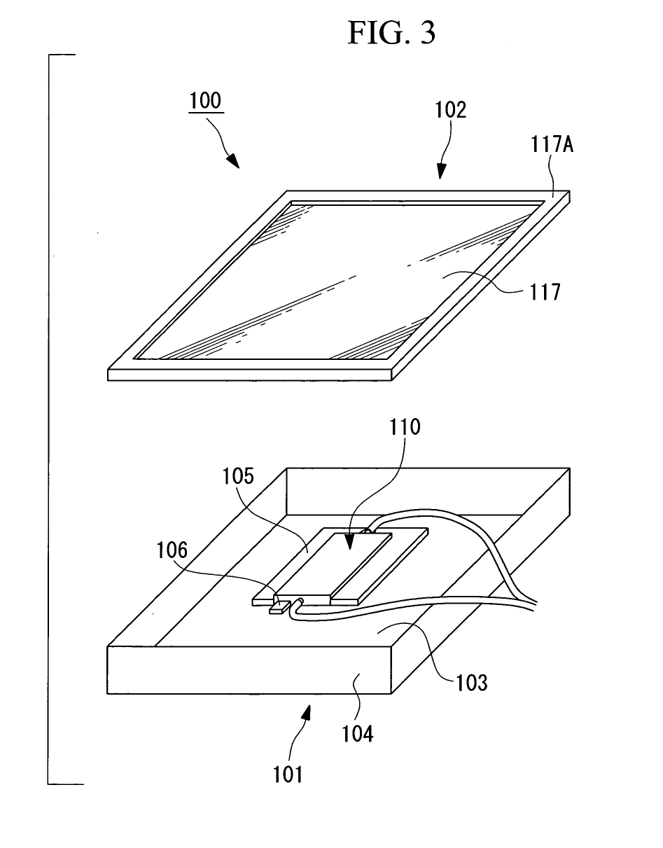

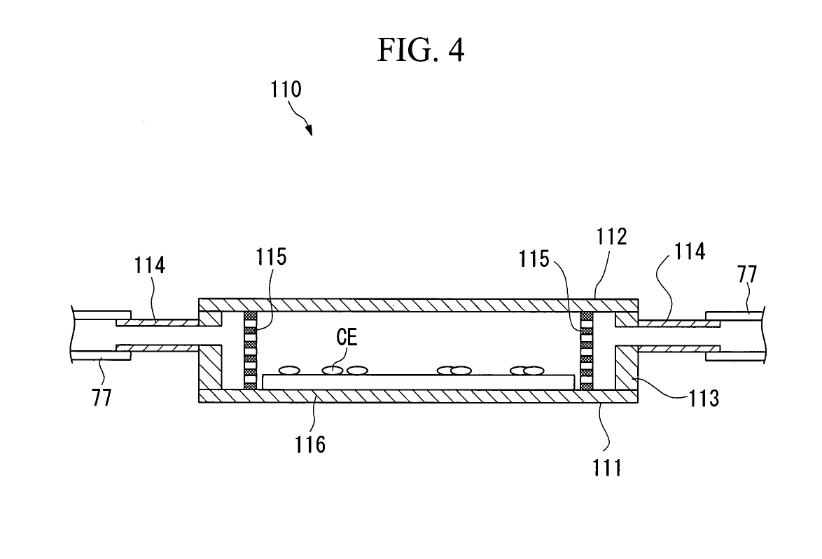

FIG. 3 is a perspective view showing the incubator box according to the present embodiment. FIG. 4 is a cross-sectional view of the chamber according to the present embodiment.

As shown in FIG. 3 and FIG. 4, the incubator box 100 schematically comprises a box body 101 which stores the chamber 110, and a cover 102 which forms an enclosed space together with the box body 101. A magnetic sealing treatment for shutting out the magnetic field from the outside, and a static elimination treatment for eliminating the static electricity generated in the incubator box 100, are applied to the box body 101 and the cover 102.

The box body 101 is formed from a bottom plate 103 and a side wall 104. The region corresponding to the measurement area on the bottom plate 103 is made from a material having transmittance such as glass. The other region on the bottom plate 103 and the side wall 104 are preferably made from a metal such as an alumite coated aluminum, or a material having a high shading property such as a stainless steel like SUS316. From the viewpoint of the heat retaining property, it is more preferable to select a material having low heat conductivity.

Moreover, an adaptor 105 for holding the chamber 110, and a temperature sensor 106 which measures the temperature of the chamber 110, are arranged on the bottom plate 103. The chamber 110 may be held using the adaptor 105 as described above, or it may be held not using the adaptor 105.

The output from the temperature sensor 106 is inputted into the computer PC via an incubator temperature detection section 106S, and is also inputted into a temperature display section 107 arranged on the wall surface of the detection unit 20. The computer PC controls the heater 21H and the like via the incubator temperature control section 106C shown in FIG. 2, so as to control to keep the temperature in the incubator box 100 constant.

The cover 102 comprises a glass plate 117 through which the illuminating light is transmitted, and a support 117A which supports the glass plate 117. Anti-reflection films may be formed on the both sides in a region corresponding to the measurement area. By forming the anti-reflection films on the both sides, the reflection by the glass plate 117 during the transmission observation/incident light observation can be avoided.

The dimensions of the glass plate 117 may be approximately the same as the dimensions of the bottom plate 103 of the incubator box 100, or may be the minimum dimensions required for measurement without problems.

As shown in FIG. 4, the chamber 110 is schematically formed from a bottom glass member 111 for observing by the object lenses 48, a top glass member 112 for transmitting light from the transmitted light source 23, and a frame member 113 which supports the bottom glass member 111 and the top glass member 112.

A joint 114 formed with a passage for letting the culture solution circulate, is formed on the side facing the frame member 113. A culture solution circulation pipeline 77 described later is connected to the joint 114, so that the culture solution circulates between the culturing unit 70 and the chamber 110.

Moreover, on the frame member 113, a commutator 115 which make the flow of the culture solution uniform, are arranged approximately perpendicularly to the flow of the culture solution. The commutator 115 is made from a plate member in which small pores are formed in matrix form, and the culture solution dispersingly flows through a plurality of the formed small pores, by which the flow is made uniform. Moreover, a slide glass 116 having cells CE disseminated thereon, is arranged between the two commutators 115.

As a result, outside of the space formed in the chamber 110 there is a space formed in the box body 101 of the incubator box 100, and further outside thereof there is a space formed in the heat insulating box 21.

Therefore, with respect to the space formed in the chamber 110 serving as the culturing space, the space formed in the box body 101 functions as the buffering space (first buffering space) for relieving (buffering) the effect from the outside (outside of the box body 101 or the heat insulating box 21), and the space formed in the heat insulating box 21 functions as the buffering space (second buffering space) for relieving (buffering) the effect from the outside (outside of the heat insulating box 21).

Moreover, the spaces formed respectively inside of the heat insulating box 21, the box body 101 of the incubator box 100, and the chamber 110 are substantially isolated from the outside.

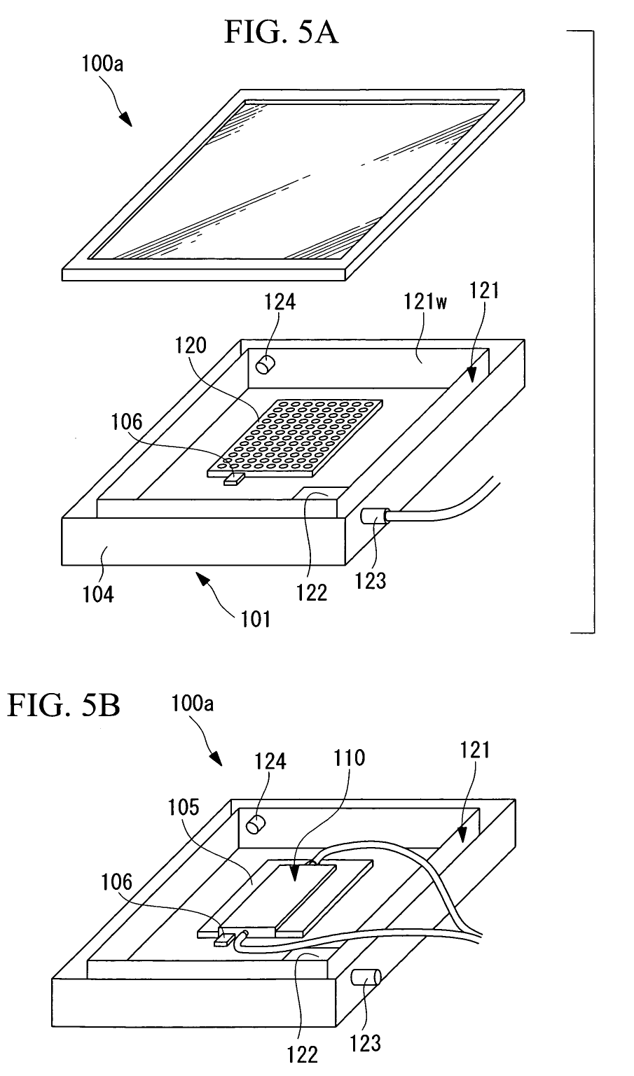

As described above, the incubator box 100 may have the chamber 110 arranged inside, or may have the microplate 120 (or a well plate) arranged inside as shown in FIG. 5A.

In this structure, as shown in FIG. 5A, a water bath 121 enclosing the microplate 120 in a square shape, an internal fan 122 arranged inside of the water bath 121, a connector 123 which supplies a culture gas, and a culture gas concentration sensor 124 which detects the carbon dioxide concentration in the culture gas, are arranged in the box body 101 of the incubator box 100a.

The temperature sensor 106 is arranged to measure the temperature of the microplate 120. The microplate temperature inputted from the temperature sensor 106 into the computer PC is saved into a memory as text data which can be used for data processing in the computer PC.

The culture gas concentration sensor 124 outputs the carbon dioxide concentration to the computer PC and to the culture gas concentration display section 124D.

The side wall 104 of the water bath 121 is formed lower than the height of the side wall. Moreover, the layout for the connector 123 is adjusted so that the supplied culture gas impinges on the side wall 121W. Sterilized water is stored in the water bath 121 to adjust the humidity in the incubator box 100a to approximately 100%.

The internal fan 122 is arranged so as to blow along the side wall 104 of the water bath 121, so that the microplate 120 is not arranged in the flow direction.

The culture gas concentration sensor 124 may be arranged on the inner surface of the side wall 121W of the water bath 121. Alternatively, the pipeline may be arranged from the incubator box 100a to the outside to draw the culture gas in the incubator box 100a by a suction pump so that the culture gas concentration sensor 124 detects the concentration.

When such an incubator box 100a is used, since the culture gas supply destination of the culture gas mixing bath 91 described later is changed from the culture solution bottle 72 to the incubator box 100a, and there is no necessity to supply the culture solution from the culturing unit 70, then the operation of various pumps such as a culture solution pump 80 is stopped.

By having such a structure, the humidity environment and the culture gas concentration for which a change or irregularity causes less damage to the cells CE compared to the thermal environment, are maintained by the incubator box 100a. Therefore the damage to the cells CE can be decreased.

Moreover, since the humidity and the culture gas concentration are maintained in the incubator box 100a which is not directly in contact with the detection section 40, the contamination during the observation can be prevented.

Furthermore, since it is not necessary to maintain the humidity and the culture gas concentration suitable for culturing the cells CE, inside the heat insulating box 21, the loss of the function of the object lens 48 and the like arranged in the heat insulating box 21 due to the humidity can be prevented. Moreover, shortening of the lifetime of the object lens 48 and the like can be prevented.

As a result, the space formed inside the heat insulating box 21 exists on the outside of the space formed in the box body 101 of the incubator box 100a.

Therefore, with respect to the space formed in the box body 101 serving as the culturing space, the space formed in the heat insulating box 21 functions as the buffering space for relieving (buffering) the effect from the outside (outside of the heat insulating box 21).

Moreover, the spaces formed respectively inside of the heat insulating box 21 and the box body 101 of the incubator box 100 are substantially isolated from the outside.

The chamber 110 may be closed as described above, or may be an open type chamber that is not closed. The open type chamber is formed to have the same structure as that of the chamber 110 except for the point that the top glass member 112 is not provided.

Moreover, if the open type chamber is used, the incubator box 100a is filled with the culture gas using the abovementioned incubator box 100, and the culture solution is supplied to the open type chamber.

As shown in FIG. 5B, the chamber 110 may be used for the incubator box 100a. In this case, the connector 123 which supplies the culture gas is closed off, and the culture gas concentration sensor 124 is not used. Moreover, if the size of the chamber 110 is different from that of the microplate 120, the chamber 110 may be arranged on the incubator box 100a using the adaptor 105. Furthermore, the sterilized water need not be put into the water bath 121, and the water bath 121 itself may be taken out from the incubator box 100a. The temperature sensor 106 measures the temperature of the chamber 110.

The connector 123 may be closed off as described above, or the supply of the culture gas to the incubator box 100a may be simply stopped while the culture gas supply pipeline 97 is connected.

As shown in FIG. 1 and FIG. 2, the culturing unit 70 schematically comprises a sterile box 71 which stores the culture solution inside, and a mixing section 90 which generates the culture gas.

The sterile box 71 comprises; a heater 71H which keeps the inside of the sterile box 71 warm at a predetermined temperature, a culture solution bottle 72 which stores the culture solution inside, a spare tank 73 which stores the spare culture solution inside, a waste tank 74 into which the used culture solution is put, a UV lamp 25 which sterilizes the inside of the sterile box 71, an openable and closable cover 75 which is used for putting in and taking out the culture solution bottle 72 or the like from the sterile box 71, and a main power switch 76 which turns ON/OFF the main power source of the culturing unit 70.

A culture solution circulation pipeline 77 for letting the culture solution circulate between the incubator box 100 and the culture solution bottle 72, a supply pipeline 78 which supplies the spare culture solution from the spare tank 73, and a waste pipeline 79 which discharges the used culture solution from the culture solution bottle 72 to the waste tank 74, are arranged on the culture solution bottle 72.

A culture solution pump (culture solution exchange section) 80 which delivers the culture solution from the culture solution bottle 72 to the incubator box 100 to let the culture solution circulate, is arranged on the culture solution circulation pipeline 77. Since the culture solution in the chamber 110 can be exchanged for a new solution by the culture solution pump 80, the period during which the cells CE can be cultured can be extended compared to the case where the culture solution can not be exchanged.

A supply pump 81 which sends the culture solution from the spare tank 73 to the culture solution bottle 72, is arranged on the supply pipeline 78. A waste pump 82 which sends the used culture solution from the culture solution bottle 72 to the waste tank 74, is arranged on the waste pipeline 79.

As described above, the waste tank 74 which stores the used culture solution may be used. Alternatively, a drainage port which discharges the used culture solution directly to the outside may be provided without using the waste tank 74.

A culture solution temperature sensor (not shown) which detects the temperature of the inside of the culture solution is arranged on the culture solution bottle 72, so that the output from the culture solution temperature sensor is inputted into the computer PC via a culture solution temperature detection section 83. Moreover, the data of the temperature of the culture solution inputted into the computer PC is saved into a memory as text data so as to be used for comparison/verification with the detection result of the cells CE.

For the heater 71H, there is arranged a culture solution temperature control section 84 which controls the temperature of the culture solution through the temperature in the sterile box 71 based on the instructions from the computer PC. The temperature of the culture solution supplied from the culture solution bottle 72 is kept at approximately 37° C. by the culture solution temperature control section 84 to avoid a decrease in the activity of cells CE due to the temperature change of the culture solution. Moreover, a temperature display section 85 which displays the culture solution temperature detected by the abovementioned culture solution temperature sensor, is arranged on the wall surface of the culturing unit 70.

A culture solution pump control section 86 which controls the circulation of the culture solution based on the instructions from the computer PC, is arranged on the culture solution pump 80. Moreover, the supply pump 81 and the waste pump 82 are arranged so that the operation is controlled based on the instructions from the computer PC.

The UV lamp 25 is connected to the UV lamp switch 36 arranged on the wall surface of the culturing unit 70. A timer 37 which controls the operation of the UV lamp 25 timewise is arranged between the UV lamp 25 and the UV lamp switch 36. Furthermore, there is arranged a sterilization indicator lamp (not shown) which indicates if the UV lamp 25 is turned on.

The UV lamp 25 is controlled separately from the main power switch 76, and can be operated even if the main power source is turned off.

As shown in FIG. 1 and FIG. 2, a heater (not shown) which keeps the inside of the mixing section 90 warm at a predetermined temperature, a culture gas mixing bath 91 which controls the carbon dioxide concentration in the culture gas to be supplied to the incubator box 100, and a CO2 pump 93 which supplies carbon dioxide from a CO2 tank 92 arranged outside of the culturing unit 70 to the culture gas mixing bath 91, are arranged in the mixing section 90.

On the culture gas mixing bath 91, a CO2 concentration detection section 94 which detects the carbon dioxide concentration of the inside thereof is arranged, so that the output from the CO2 concentration detection section 94 is inputted to the computer PC. A CO2 concentration control section 95 which controls the amount of carbon dioxide to be supplied to the culture gas mixing bath 91 based on the instruction from the computer PC, is arranged for the CO2 pump 93. Moreover, a CO2 concentration display section 96 which displays the carbon dioxide concentration in the culture gas mixing bath 91 detected by the CO2 concentration detection section 94, is arranged on the wall surface of the culturing unit 70.

Furthermore, a culture gas supply pipeline 97 is arranged between the culture gas mixing bath 91 and the culture solution bottle 72. Therefore, a culture gas can be supplied to the culture solution via the culture gas supply pipeline 97 so as to sufficiently blend the culture gas into the culture solution. In this manner, a culture solution with 5% concentration of carbon dioxide dissolved is generated in the culture solution bottle 72, so that the culture solution including culture gas and essential nutrition for growing the cells CE can be supplied to the chamber 110 described later. Moreover, by dissolving the culture gas into the culture solution, the pH and the like of the culture solution can be adjusted.

The carbon dioxide concentration inputted from the CO2 concentration detection section 94 to the computer PC is saved into a memory as data, and data processing is made possible in the computer PC.

Next is a description of an observation method for the biological sample observation system 10 having the abovementioned structure.

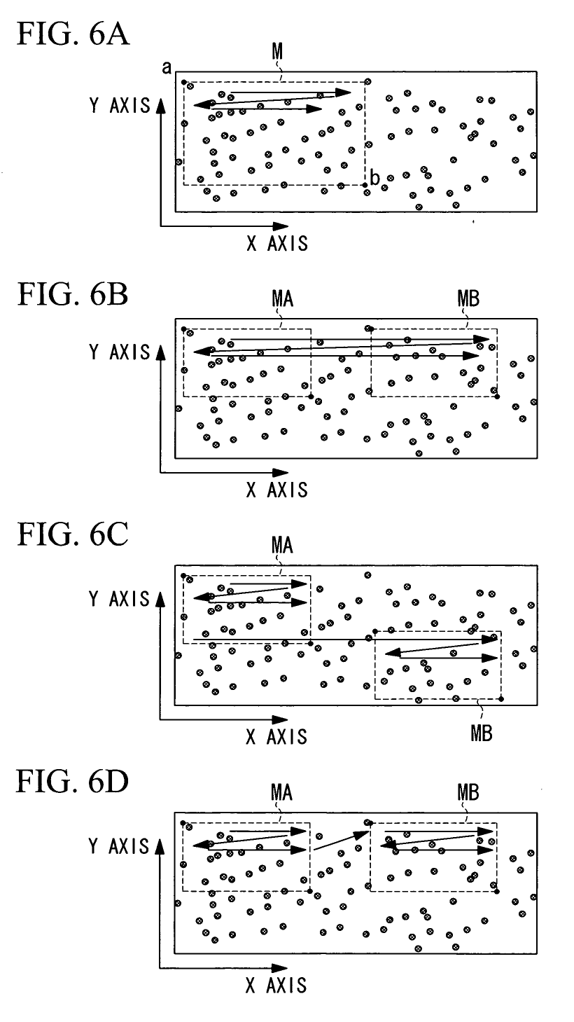

First is a description of the selection for the scan method and the detection range in the present embodiment, with reference to FIG. 6A, FIG. 6B, FIG. 6C, and FIG. 6D.

FIG. 6A, FIG. 6B, FIG. 6C, and FIG. 6D show selected examples of the scan method and the detection range in the present embodiment.

In the example shown in FIG. 6A, a measuring object range M (the range enclosed by broken lines in the drawing) is set by specifying a point a on the top left and a point b on the bottom right of the measuring object range M on the displayed image. Specifically, the measuring object range M may be set by dragging between the points a and b using a device such as a mouse, or may be specified by inputting the coordinate value of the point a and the point b.

As shown by the arrows in the drawing, the measurement part for the detector 49 is scanned vertically in the set measuring object range M. That is, in the drawing, it is scanned in parallel with the X direction when scanned from the left to the right, and it is scanned downwards to the left when scanned from the right to the left. Of these scans, the image of the cells CE is captured when it is scanned from the left to the right.

FIG. 6B is an example for where there are two measuring object ranges M set by the abovementioned method. Firstly, two measuring object ranges MA and MB are set by the abovementioned method. In the drawing, the setting is such that the measuring object range MA and the measuring object range MB are aligned with a predetermined interval in the X direction, and they are wholly overlapped in the Y direction.

As shown by the arrows in the drawing, the measurement part for the detector 49 in this example is scanned to measure the measuring object ranges MA and MB side-by-side. That is, in the drawing, it is scanned from the measuring object range MA to the measuring object range MB when scanned from the left to the right, and it is scanned from the measuring object range MB to the measuring object range MA when scanned from the right to the left.

FIG. 6C is an example for where there are two measuring object ranges set by the abovementioned method and the arrangement of the two measuring object ranges MA and MB is different. Here, in the drawing, the setting is such that the measuring object range MA and the measuring object range MB are lined up with a predetermined interval in the X direction, and they are partly overlapped in the Y direction.

As shown by the arrows in the drawing, regarding the measurement part for the detector 49 in this example, only the part of the measuring object ranges MA and MB which is overlapped in the Y direction is continuously scanned. That is, firstly the part of the measuring object range MA which is not overlapped is scanned. Next, the part of the measuring object ranges MA and the MB which is overlapped in the Y direction is continuously scanned. Then, the part of the measuring object range MB which is not overlapped is scanned.

FIG. 6D is an example for where there are two measuring object ranges M set by the abovementioned method, and the arrangement of the two measuring object ranges MA and MB is similar to that of FIG. 6B but the scan method is different.

As shown by the arrows in the drawing, regarding the measurement part for the detector 49 in this example, the measuring object ranges MA and MB are separately scanned. That is, firstly the measuring object range MA is wholly scanned, and then the measuring object range MB is wholly scanned.

Moreover, among the abovementioned scan methods shown in FIG. 6A, FIG. 6B, FIG. 6C, and FIG. 6D, the scan method by which the total moved distance or the scanning time becomes the shortest is automatically selected by the computer PC, based on a set parameter and measurement mode described later.

When capturing an image of the range where the cells are cultured, if the structure is such that the images of a plurality of regions (detection range) can be separately captured by for example, setting the measuring object ranges M in this manner, then as necessary it is possible to capture only the image of the necessary part.

For example, if the setting of the computer PC is changed so as to alternatively scan the whole range, being the scanning object, and a predetermined part of the region, a phenomenon peculiar to the biological sample occurring only for a short period can be captured. As an example, in the case where the whole range being the scanning object, is scanned every 30 minutes, if the predetermined measuring object range M where the noteworthy cells are present is scanned during this time, it becomes possible to capture any peculiar phenomenon that appears for only about 15 minutes, occurring in the noteworthy cells.

Moreover, since only the necessary measuring object range M is scanned when needed, the scanning time can be shortened and the light irradiation time to the other cells can be shortened.

Next is a description of the procedure taken to measure the cells CE, using respective flowcharts.

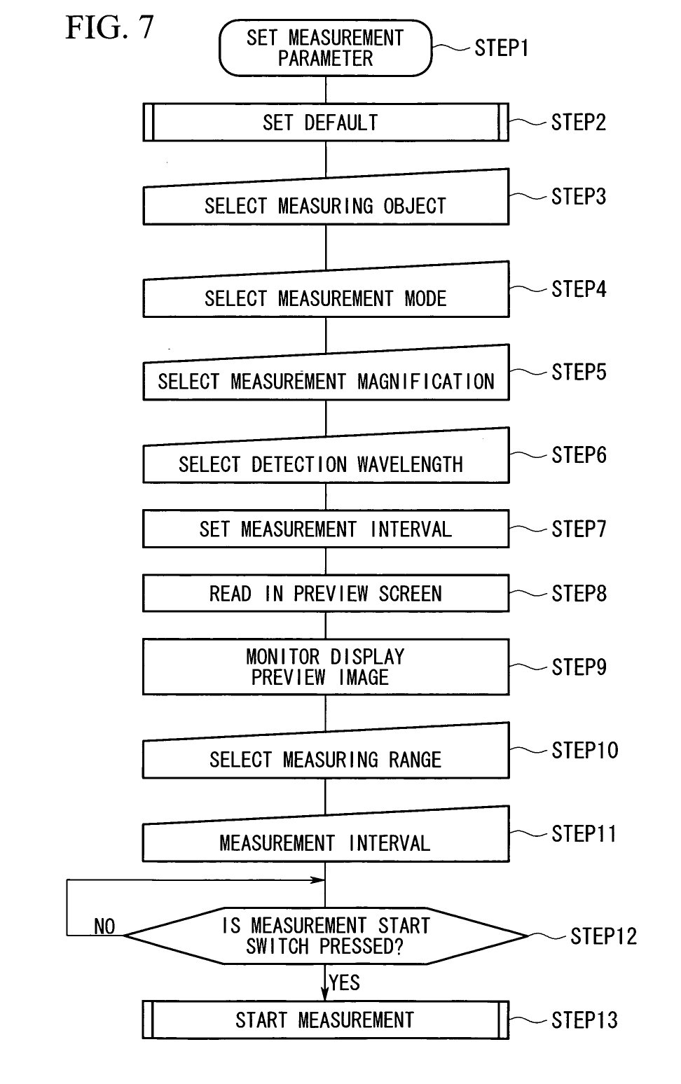

Firstly, the measurement parameter is set prior to the measurement of the cells CE. Here, the flow of the measurement parameter setting is described with reference to FIG. 7.

FIG. 7 is a flowchart describing the flow of the measurement parameter setting in the present embodiment.

Firstly, the measurement parameter is set (STEP 1).

Then, default conditions are set (STEP 2). The conditions set here are for example a measurement condition and a culture condition such as the CO2 concentration is 5% and the temperature is 37° C. These set conditions can be changed into predetermined conditions by a user.

Next, the measuring object is selected (STEP 3). The measuring object is a container of the cells CE such as the microplate 120 or the slide glass 116 for example.

Next, the measurement mode is selected (STEP 4). The measurement mode includes an area imaging mode, a line imaging mode, an automatic mode, and the like. The automatic mode is a mode for automatically selecting a measurement mode in which the measuring time or the scanning time is short, from among the other measurement modes.

Next, the measurement magnification is selected (STEP 5), and then the detection wavelength is selected (STEP 6). In the selection of the measurement magnification, and the selection of the detection wavelength, selection can be made from each of two or more kinds of alternatives.

Here, as the selection method of the detection wavelength, the list of fluorescent proteins to be used, such as GFP, HC-Red, and the like is previously stored in the computer PC, and the fluorescent protein is selected from the stored list. Based on the selected fluorescent protein, the computer PC automatically selects the excitation filter 56, the absorption filter 58, and the like, that is optimum for the observation. In this manner, a predetermined fluorescence from the cells CE can be detected.

During the measurement, the excitation filter 56, the absorption filter 58, the object lenses 48, and the like, are automatically changed in synchronous with the drive of the X axis operation stage 22X, and the Y axis operation stage 22Y.

Next, the measurement interval is set (STEP 7).

Then, the preview image is read in (STEP 8), and the preview image is displayed on the monitor (STEP 9). Here, the preview image is displayed on the monitor under the user's instruction using a preview button which instructs displaying of the preview image on the monitor. Then, the user can confirm the preview image displayed on the monitor.

Next, the measuring range is selected (STEP 10). After the measuring range is selected, the preview image may be displayed on the monitor again so as to confirm that the measuring range is the predetermined range.

Next, a predetermined measurement interval is selected from a plurality of set measurement intervals (STEP 11).

Then, if the measurement start switch (not shown) is pressed (STEP 12), the measurement of the cells CE is started (STEP 13). If the measurement start switch is not pressed, the state remains in standby until the measurement start switch is pressed (STEP 12).

The setting may be such that, if the measurement start switch is not pressed in STEP 12, the flow can return to various predetermined STEPs so as to be able to set various settings again.

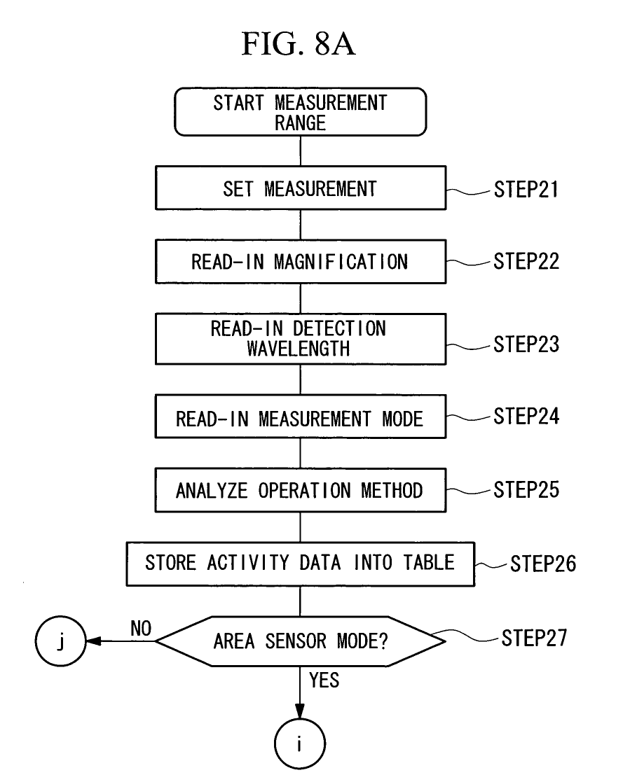

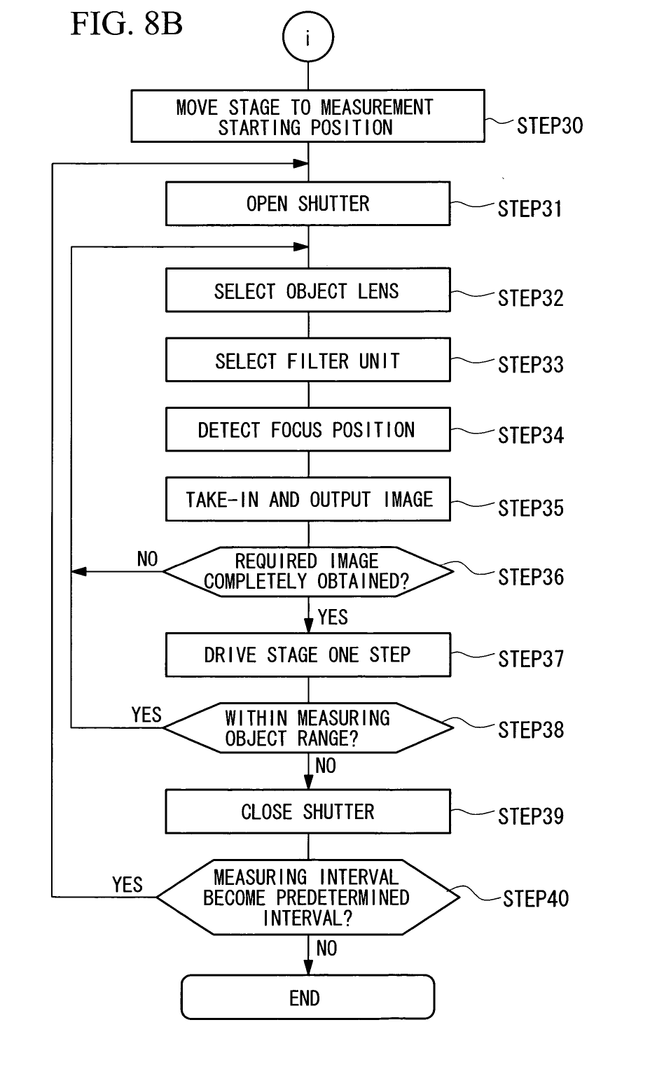

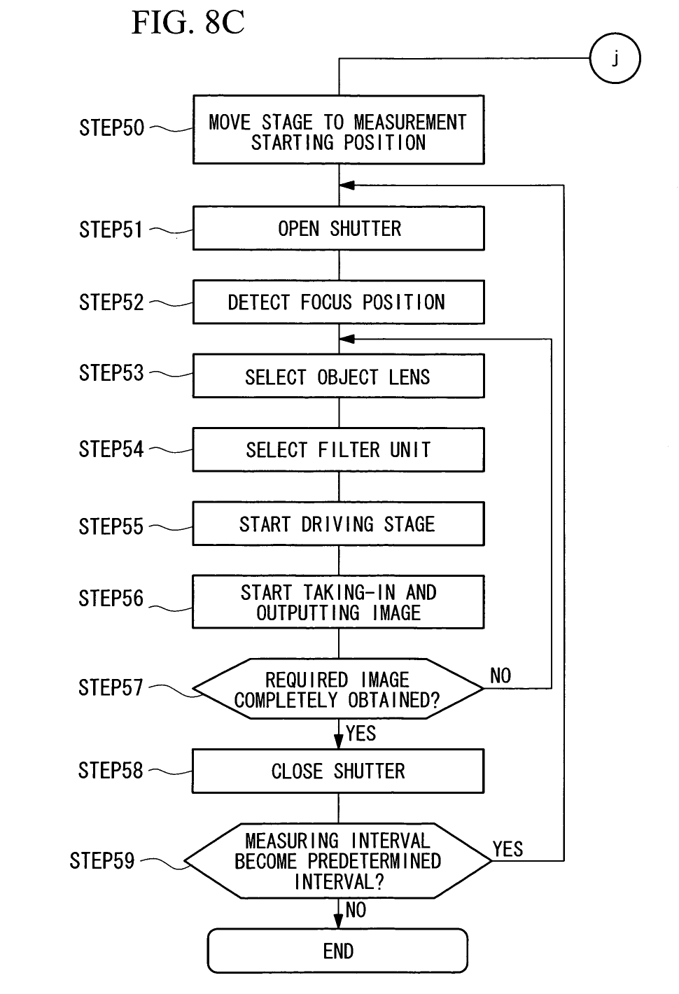

If the measurement parameter setting is completed, then next the cells CE are observed. Therefore the flow of measurement of the cells CE, is described with reference to FIG. 8A, FIG. 8B, and FIG. 8C

FIG. 8A, FIG. 8B, and FIG. 8C are flowcharts describing the flow of measurement according to the present embodiment.

Firstly, as shown in FIG. 8A, when the measurement is started, the measuring object range is read-in (STEP 21). Then the magnification is read-in (STEP 22), and the detection wavelength is read-in (STEP 23).

Next, the measurement mode is read-in (STEP 24). Here, the optimum stage scan method is determined based on the read measuring object range, the magnification, the detection wavelength (fluorescence wavelength), and the like. If the measurement mode is set to the automatic mode, the imaging mode is also determined here.

Next, the operation method of the X axis operation stage 22X, the Y axis operation stage 22Y, and the like according to the determined stage scan method is analyzed (STEP 25), and the data (activity data) of the analyzed operation method is stored into the table of the computer PC (STEP 26).

Then, the measurement is performed by a different measuring method according to whether or not the area sensor mode is selected (STEP 27).

First is a description of a case where the area sensor mode is selected, with reference to FIG. 8B.

If the measurement start switch is pressed, the X axis operation stage 22X and the Y axis operation stage 22Y are moved to the measurement starting position (STEP 30). Here, the computer PC reads-in the inputted measurement starting position so that the X axis operation stage 22X and the Y axis operation stage 22Y are moved to the measurement starting position, and the cells CE are moved to the position within the imaging visual field of the object lens 48.

Then, the shutter 35 is opened (STEP 31), and the object lens 48 is selected (STEP 32). Here, based on the set measurement magnification, the computer PC drives the revolver 47 to select the object lens 48 of the predetermined magnification.

Next, the filter unit 45 is selected (STEP 33). Here, based on the set fluorescent protein, the computer PC selects the excitation filter 56, the absorption filter 58, and the like that are optimum for the observation.

The abovementioned operation from pressing the measurement start switch up to here (from STEP 30 to STEP 33) is automatically selected and executed according to the measurement mode.

Then, the focus position is detected (STEP 34), and the image is taken-in and the image data is outputted to the image memory section of the computer PC (STEP 35).

Then, if the required image is not completely obtained, the operation from selecting the object lens 48 (STEP 32) to taking-in the image and outputting the image data to the image memory section of the computer PC (STEP 35) is repeated until the required image is completely obtained (STEP 36).

When the required image is completely obtained, the X axis operation stage 22X or the Y axis operation stage 22Y is driven by one step (STEP 37). If the position where the X axis operation stage 22X or the Y axis operation stage 22Y is moved, is within the measuring object range, then the operation from selecting the object lens 48 (STEP 32) to driving the stage by one step (STEP 37) is repeated. The repetitive operation is repeated until the position where the stage 22 is moved, becomes outside of the measuring object range (STEP 38).

When the moved destination of the X axis operation stage 22X or the Y axis operation stage 22Y becomes outside of the measuring object range, the shutter 35 is shut off (STEP 39).

Then when the measuring time interval becomes a predetermined interval, the operation from opening the shutter 35 (STEP 31) to closing the shutter 35 (STEP 39) is repeated until the measuring time is finished (STEP 40).

Next is a description of a case where the area sensor mode is not selected, with reference to FIG. 8C.

If the measurement start switch is pressed, the X axis operation stage 22X and the Y axis operation stage 22Y are moved to the measurement starting position (STEP 50). Here, the computer PC reads-in the inputted measurement starting position so that the X axis operation stage 22X and the Y axis operation stage 22Y are moved to the measurement starting position, and the cells CE are moved to the position within the imaging visual field of the object lens 48.

Then, the shutter 35 is opened (STEP 51), and the focus position is detected (STEP 52).

Next, the object lens 48 is selected (STEP 53). Here, based on the set measurement magnification, the computer PC drives the revolver 47 to select the object lens 48 of the predetermined magnification.

Then, the filter unit 45 is selected (STEP 54). Here, based on the set fluorescent protein, the computer PC selects the excitation filter 56, the absorption filter 58, and the like that are optimum for the observation for the filter control section 46C.

The operation from pressing the measurement start switch up to here (from STEP 50 to STEP 54) is automatically selected and executed according to the measurement mode.

Then, drive of the X axis operation stage 22X and the Y axis operation stage 22Y is started (STEP 55), and the image is taken-in and the image data is outputted to the memory section of the computer PC (STEP 56).

Then, if the required image is not completely obtained, the operation from selecting the object lens 48 (STEP 53) to taking-in the image and outputting the image data into the memory section of the computer PC (STEP 56) is repeated until the required image is completely obtained (STEP 57).

When the required image is completely obtained, the shutter 35 is closed (STEP 58)

Then when the measuring time interval becomes a predetermined interval, the operation from opening the shutter 35 (STEP 51) to closing the shutter 35 (STEP 58) is repeated until the measuring time is finished (STEP 59).

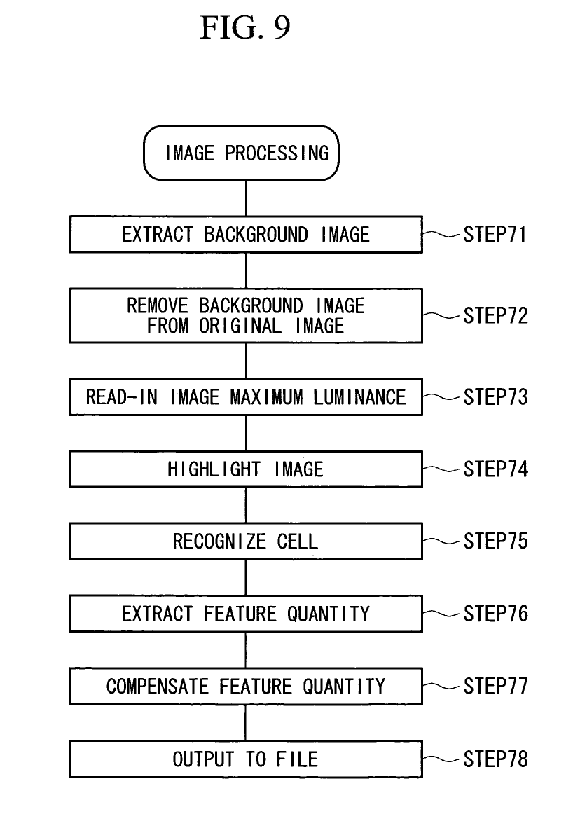

Once the observation/capturing the image of the cells CE has been terminated, then next the captured image is processed. Here is a description of the processing method of the captured image, with reference to FIG. 9.

FIG. 9 is a flowchart describing the image processing method.

Firstly, the image processing section of the computer PC recognizes the background image from the captured image stored in the memory section (STEP 71), and removes the background image (background) from the captured image (STEP 72).

Next, the maximum luminance range of a highlitable image is read-in (STEP 73), and the image is highlighted for example by multiplying by a predetermined coefficient according to the maximum luminance range (STEP 74). By these processings, the image is highlightened from the image for which the background has been removed, so that the cells CE can be readily recognized in the granular form one by one.

Then, by extracting parts having for example the luminance of a predetermined threshold or more from the highlightened image, the luminance of each cell CE can be recognized in a clear granular form one by one (STEP 75).

Next, a geometrical feature quantity such as the position of the center of gravity or the area, a chemical feature quantity, an optical feature quantity such as fluorescent luminance of the cell CE, are accurately recognized and extracted in association with the information of the position of the cell CE (STEP 76). By extracting the feature quantities, the cells CE can be recognized one by one.

After the extraction of the feature quantities of the cells CE, the highlighting operation (STEP 74) that has been performed to recognize the cells CE is compensated for (STEP 77). By this compensation, the effect of the predetermined coefficient used for highlighting the image is eliminated.

Next, the compensated feature quantities are outputted, for example to a file, and stored in the file (STEP 78).

Therefore, the image processing section of the computer PC can form the image of the distribution of the fluorescent light quantity of the cells CE in the respective positions on the whole surface of the slide glass, the microplate, or the like. Moreover, since the image processing section can trace the cells CE accurately one by one, it is possible to focus on a predetermined number of cells CE and locally measure the fluorescent distribution inside of the cells CE for a long time while culturing them. Furthermore, it is also possible to measure the whole surface of the slide glass, the microplate, or the like at each fixed timing while culturing the cells CE, so as to automatically measure the fluorescent light quantity of the cells CE with respect to the passage of time.

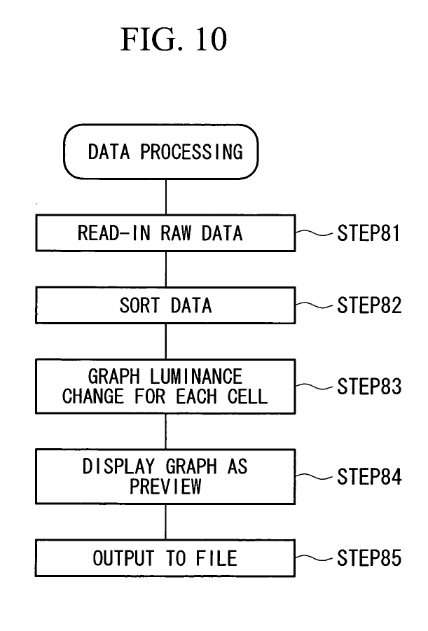

Next is a description of the data processing performed after extraction of the data such as the feature quantities of the cells CE from the captured image, with reference to FIG. 10.

FIG. 10 is a flowchart describing the flow of data processing.

Here, the data (feature quantities) of the cells CE stored in the file by the data processing section of the computer PC are processed.

Firstly, the data processing section reads-in the raw data (feature quantities) of the cells CE stored in the file (STEP 81), and the data is sorted so as to be arranged in time series for each cell (STEP 82). After the data is sorted, the data processing section graphs the change with time of the luminance, that is, the expression level, for each cell CE (STEP 83).

When the graph is completed, the data processing section displays the graph as a preview (STEP 84), and the graphed data is outputted to the file (STEP 85).

By performing the processing, the change with time of a cell for where the cells CE have been cultured for a long time, can be readily observed. Consequently, the change with time of the expression level of the cells CE during the culturing and the like can be accurately and readily measured.

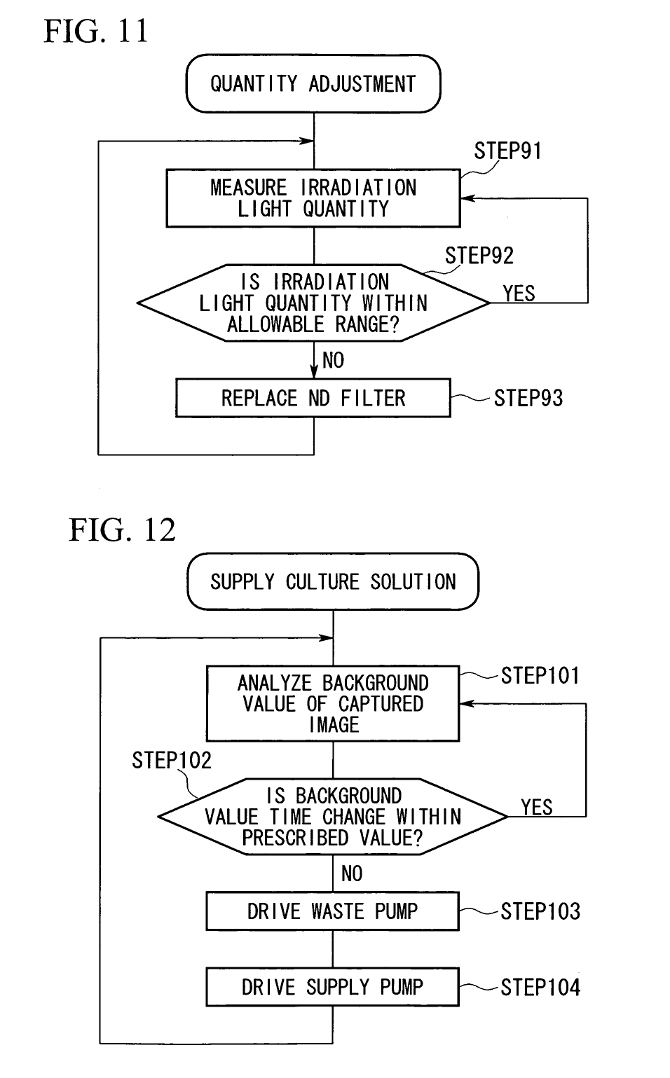

Next is a description of the adjustment of the irradiation light quantity performed at the time of measuring the cells CE, with reference to FIG. 11.

FIG. 11 is a flowchart describing the flow of light quantity adjustment.

Firstly, the light quantity of the light irradiated onto the cells CE is measured (STEP 91). The irradiation light quantity may be calculated from the output of the light quantity monitor 50, may be measured by providing an illuminometer, or may be calculated by providing a power meter and calculating from the output of the power meter.

If the measured irradiation light quantity is within the allowable range, the flow returns to the measurement of the irradiation light quantity (STEP 91), and the measurement is repeated until the irradiation light quantity becomes outside of the allowable range (STEP 92).

When the irradiation light quantity becomes outside of the allowable range, the ND filter (not shown) included in the light quantity adjustment mechanism 43 is replaced (STEP 93), and the irradiation light quantity is adjusted so as to be within the allowable range. Then, the flow returns to the measurement of the irradiation light quantity (STEP 91), and the adjustment of the irradiation light quantity is repeated.

Next is a description of a control method for supplying/exchanging a culture solution to the chamber 110, with reference to FIG. 12.

FIG. 12 is a flowchart describing the supplying/exchanging method of a culture solution.

Firstly, the background value of the captured image is analyzed (STEP 101). In the background of the captured image, the image of autofluorescent light from the culture solution is captured, and the luminance of the autofluorescent light from the culture solution is analyzed.

Here, since the luminance of the autofluorescent light becomes higher as the culture solution gets older, the timing for exchanging the culture solution can be detected by measuring the luminance of the autofluorescent light.

If the change with time in the analyzed background value is a predetermined prescribed value or less, the flow returns to the analysis of the background value (STEP 101), and the analysis is repeated until the change with time in the background value becomes greater than the predetermined prescribed value (STEP 102).

When the change with time in the background value becomes greater than the predetermined prescribed value, the waste pump 82 of the culture solution is driven (STEP 103), and the supply pump 81 of the culture solution is driven (STEP 104).

The timing of supplying/exchanging the culture solution may be determined by the autofluorescent light from the culture solution as described above, or may be continual, or the supplying/exchanging may be automatically performed at a time interval previously specified by the user. Alternatively, the time for exchanging the culture solution may be appropriately specified by selecting a cell CE from a previously registered table. Moreover, the amount to be exchanged may be set by the user, may be determined by the autofluorescent light from the culture solution, or all of the culture solution in the chamber 110 may be exchanged. Alternatively, the amount of the culture solution to be exchanged may be appropriately specified by selecting a cell CE from a previously registered table. Moreover, it may be automatically set by converting by weight.

In the present embodiment, the value of the autofluorescent light of the background is detected using the captured image. However it may be detected using the image captured from the area where the cells CE are not present, or may be detected by providing for example an optical detector in the vicinity of the culture solution bottle 72.

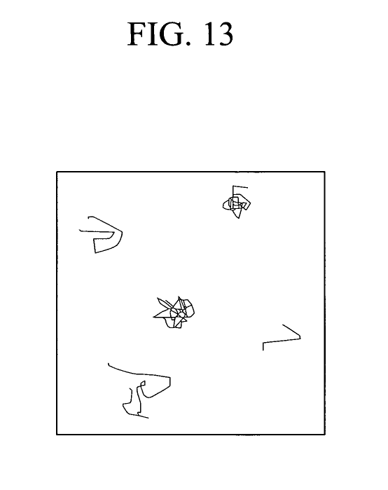

By the abovementioned measurement procedure, as shown in FIG. 13, a tracked image of the cells showing the change of the cells one by one with the passage of time can be obtained.

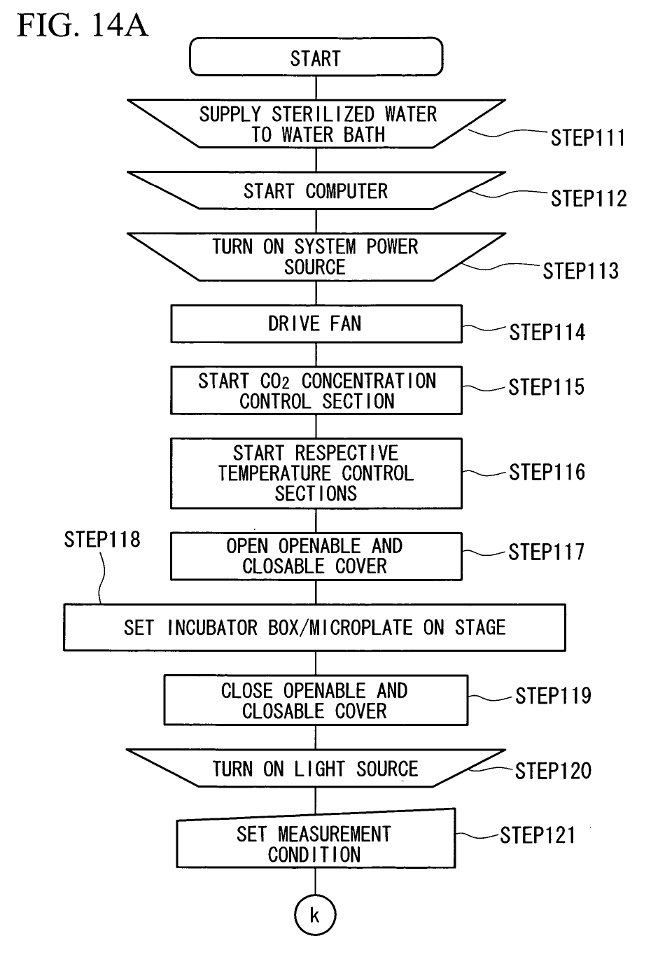

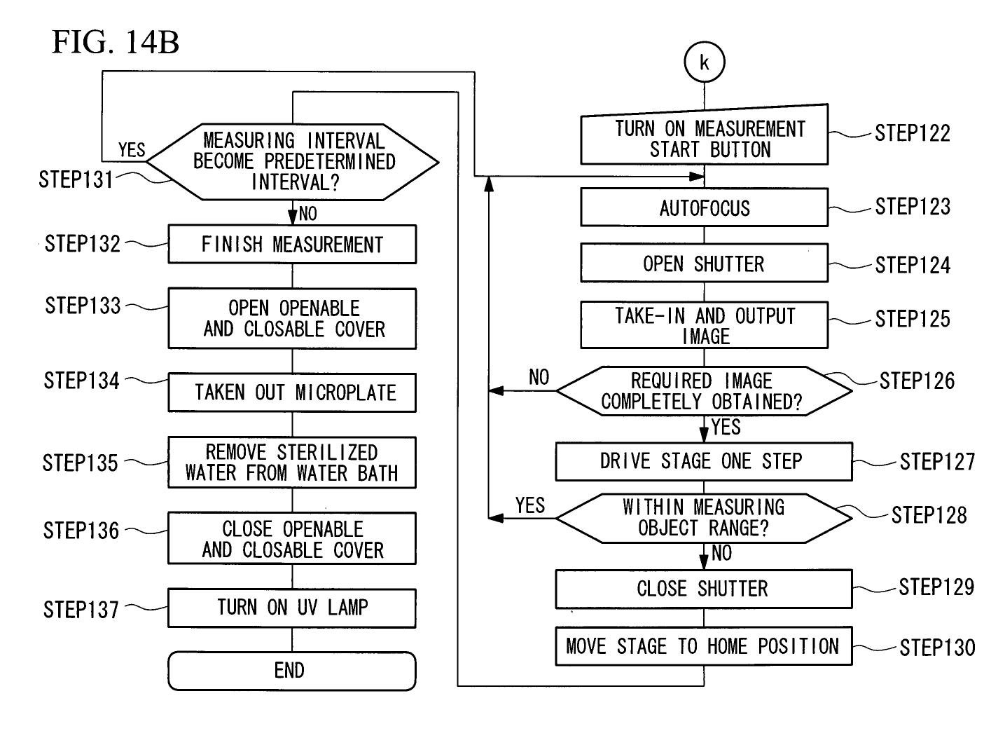

Next is a description of the procedure in the case where the culture and measurement is performed using the microplate 120, with reference to FIG. 14A and FIG. 14B.

FIG. 14A and FIG. 14B are flowcharts showing the culture and measurement using the microplate 120.

Firstly, as shown in FIG. 14A, sterilized water is supplied to the water bath 121 of the incubator box 100a (STEP 111).

Next, the computer PC is started (STEP 112), then the main power sources of the detection unit 20 and the culturing unit 70 are turned ON (STEP 113).

Then, the internal fan 122 in the incubator box 100a is driven (STEP 114) so as to circulate the air in the incubator box 100a. The CO2 concentration control section 95 is then started (STEP 115) so as to control the carbon dioxide concentration of the culture gas supplied to the incubator box 100a at 5%. Then, the respective temperature control sections are started (STEP 116) so as to control the temperature of the culture solution, the temperature of the culture gas, the temperature in the heat insulating box 21, and the like to approximately 37° C.

After that, the openable and closable cover 27 of the detection unit 20 is opened (STEP 117), and the incubator box 100a is set on the stage 22 (STEP 118), and the openable and closable cover 27 is closed (STEP 119).

Next, the transmitted light source 23 is turned ON (STEP 120) to irradiate the transmitted light onto the cells CE, and the measurement condition is set (STEP 121).

Then, as shown in FIG. 14B, the measurement of the cells CE is started by turning ON the measurement start button (STEP 122).

Firstly, the predetermined cells CE are scanned to perform autofocusing (STEP 123). When the focal positions of the respective parts are determined, the shutter 35 is opened (STEP 124).

Next, the image of the cells CE is taken-in and outputted (STEP 125). Here, the taken-in image data is outputted to the memory section of the computer PC.

Then, if the required image is not completely obtained, the operation from autofocusing (STEP 123) to taking-in and outputting the image (STEP 125) is repeated until the required image is completely obtained (STEP 126). Here, the required image means the image captured according to the selected wavelength, the image captured according to the selected magnification, or the like.

When the required image is completely obtained, the X axis operation stage 22X or the Y axis operation stage 22Y is driven by one step (STEP 127). If the position to which the X axis operation stage 22X or the Y axis operation stage 22Y is moved, is within the measuring object range, then the operation from autofocusing (STEP 123) to driving the stage by one step (STEP 127) is repeated. The repetitive operation is repeated until the position to which the stage 22 is moved, becomes outside of the measuring object range (STEP 128).

When the moved destination of the X axis operation stage 22X or the Y axis operation stage 22Y becomes outside of the measuring object range, the shutter 35 is closed (STEP 129), and the X axis operation stage 22X or the Y axis operation stage 22Y is moved to the home position (STEP 130).

Then when the measuring time interval becomes a the predetermined interval, the operation from autofocusing (STEP 123) to moving the stage to the home position (STEP 130) is repeated until the measuring time is finished (STEP 131).

When the measuring time is finished (STEP 132), the openable and closable cover 27 is opened (STEP 133), and the microplate 120 is taken out from the incubator box 100a (STEP 134). Then, the sterilized water is removed from the water bath 121 (STEP 135), and the openable and closable cover 27 is closed (STEP 136).

Then the UV lamp 25 in the heat insulating box 21 is turned on (STEP 137), to sterilize in the heat insulating box 21, and the measurement is finished.

As described above, the sterilization procedure in the heat insulating box 21 may be inserted after the measurement procedure, or may be inserted at the beginning of the measurement procedure to sterilize the heat insulating box 21 prior to the measurement.

The autofocus may be performed at each measurement of the cells CE as mentioned above, or may not be performed at each measurement.

According to the above structure, since the thermal environment is maintained by the heat insulating box 21, and the humidity environment and the culture solution environment are maintained by the chamber 110 arranged in the heat insulating box 21, the humidity environment and the culture solution environment are affected by the thermal environment, and the thermal environment is also maintained in the chamber 110.

Therefore, the rapid change an irregularity of the thermal environment that can cause damage to the cells CE can be relieved by way of the humidity environment and the culture solution environment. Hence damage to the cells CE can be reduced.

Moreover, since the chamber 110 is smaller in the volume compared to the heat insulating box 21, the humidity environment and the culture solution environment can be readily maintained and controlled, so that the cells CE can be kept from being damaged.

Since the cells CE can be observed through the heat insulating box 21, the incubator box 100, and the chamber 110, the cells CE can be observed without being damaged while they are being cultured. Therefore, the behavior inside the cells CE occurring in the process of culture can be accurately measured with time.

For example, while changing the culture condition, the reaction of the cells CE serving as the object to be observed can be measured in real time, so that the presence/absence of protein expression, the expression level, the change with time in the expression level and the like can be accurately measured.

Furthermore, damage to the activity of the cells due to a variety of operations in a single observation can be prevented, and the same cells CE can be observed for a plurality of times. Moreover, since the same cells CE can be observed for a plurality of times at intervals of time, it is not necessary to limit the experimental protocol.

Furthermore, since the detection section 40 observes the cells CE in the chamber 110 through the heat insulating box 21 and the incubator box 100, it is not necessary to put in and take out the cells CE from the chamber 110 at the time of the observation, and the cells CE can be fixed in the chamber 110 during the observation. Therefore, the same position can be accurately observed at each measurement. Moreover, contamination at the time of the observation can be prevented, and the load on the cells CE can be prevented.

Furthermore, damage to the function of the detection section 40 due to the environmental conditions (for example the combination of carbon dioxide and humidity) inside the chamber 110 can be prevented.

Moreover, since the cells CE are stored in the chamber 110 arranged in the incubator box 100 in the heat insulating box 21, the distance of the cells CE from the environment outside of the incubator box 100 can be ensured, compared to the case where the chamber 110 is not arranged in the incubator box. Therefore, the effect on the cells CE from the electric field or the magnetic field due to the drive motor of the stage 22 on the outside of the incubator box 100, and the magnet provided on the openable and closable cover 27 can be relieved.

[Second Embodiment]

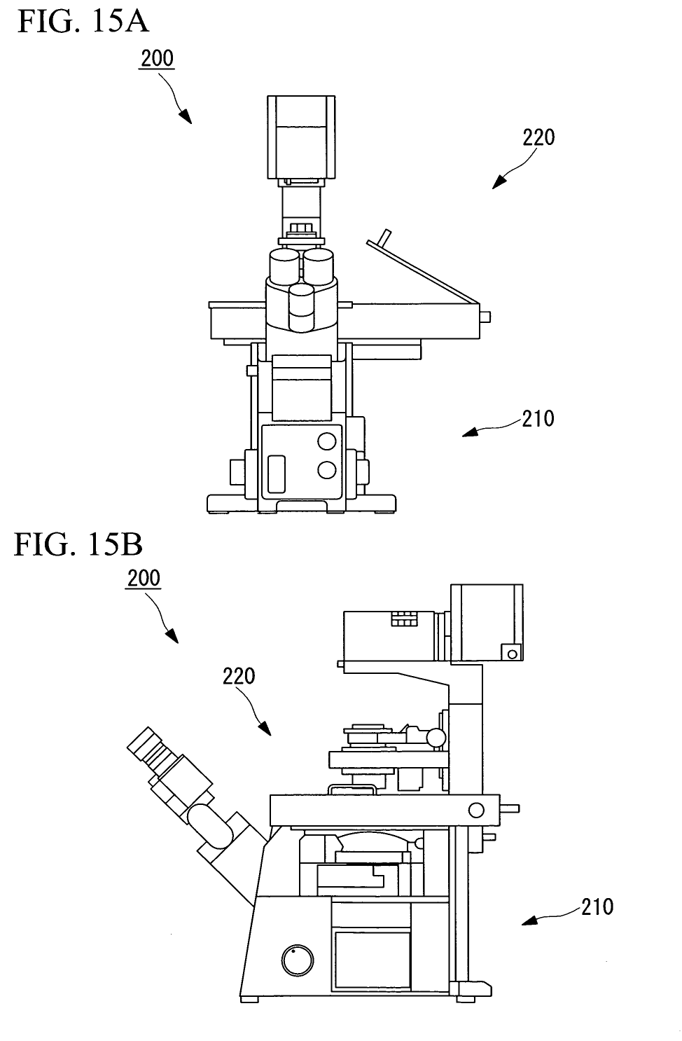

Next is a description of a second embodiment of the present invention, with reference to FIG. 15A to FIG. 17.

The basic structure of the biological sample observation system of the present embodiment is similar to that of the first embodiment. However, the structure of the detection unit and the culturing unit is different. Therefore, in the present embodiment, only the vicinity of the detection unit and the culturing unit is described using FIG. 15A to FIG. 17, and the description of the chamber and the like is omitted.

FIG. 15A is a front view of the biological sample observation system in the present embodiment, and FIG. 15B is a side view of the biological sample observation system in the present embodiment.

As shown in FIG. 15A and FIG. 15B, the biological sample observation system 200 schematically comprises an inverted type microscope (microscope) 210 and a culturing stage 220. The inverted type microscope 210 and the culturing stage 220 may be integrally fixed, or may be detachably constituted.

If the culturing stage 220 is detachable with respect to the inverted type microscope 210, an existing inverted type microscope may be also used. In this case, even if, due to formational and structural limitation relating to the attachment of the culturing stage 220 for example, the drive motor of the stage is arranged in the vicinity of the cells CE, the effect of the electricity and the magnetism on the cells CE can be relieved.

Moreover, for example, the culturing stage 220 can be attached to the inverted type microscope 210 when the cells CE are observed using the inverted type microscope 210, and the inverted type microscope 210 can be detached from the microscope at any other time (for example when the cells CE are being cultured).

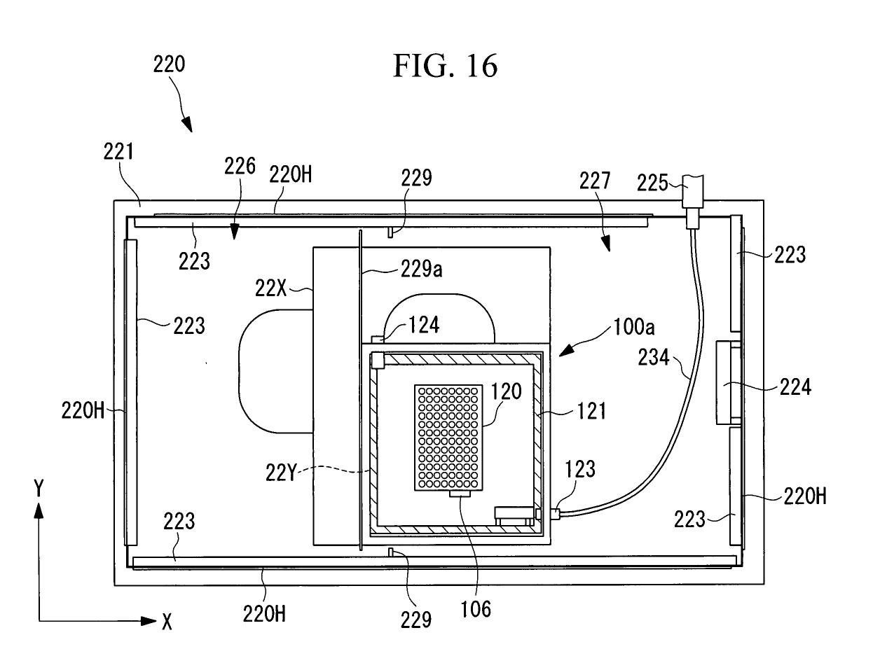

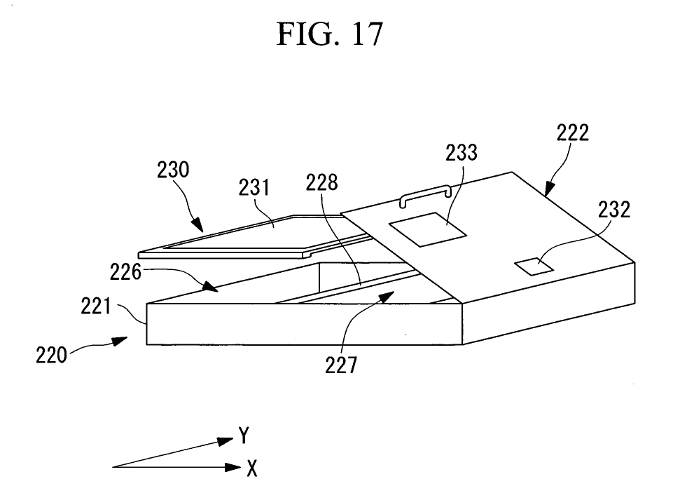

FIG. 16 is a plan view of the culturing stage 220, and FIG. 17 is a perspective view of the culturing stage 220.

As shown in FIG. 15A, FIG. 15B, and FIG. 16, the culturing stage 220 schematically comprises a box body 221, an openable and closable cover 222 provided on the top surface of the box body 221, an X axis operation stage 22X, a Y axis operation stage 22Y, a small or band-shaped heater 220H, a heat sink 223, a fan 224, and a culture gas supply connector 225.

The box body 221 is preferably made from a material having a shading property with a high anticorrosion property such as an alumite coated aluminum, or a stainless steel such as SUS316 for example. From the viewpoint of the heat retaining property, it is more preferable to select a material having low heat conductivity.

The inside of the box body 221 is divided into a measurement area 226 for observing the cultured cells, and a non-measurement area 227 where the cells are only cultured. The culturing stage 220 has a structure such that the microplate 120 for culturing and retaining the cells can be stored inside, and the cells in the microplate 120 can be observed from the outside of the culturing stage 220. Here, as shown in FIG. 16 and FIG. 17, the description is for the case where the microplate 120 is used as the culturing container, however a dish or a flask may be also used.

The fan 224 and the culture gas supply connector 225 are arranged on the side wall in the non-measurement area 227 of the box body 221. Moreover, the heater 220H and the heat sink 223 which diffuses the heat from the heater 220H are arranged in a region (including the measurement area 226) where the fan 224 and the culture gas supply connector 225 are not arranged.

The fan 224 convects the air in the culturing stage 220 and is arranged so that direct wind is not blown onto the incubator box 100a.

The temperature in the culturing stage 220 is raised by the heater 220H and is controlled to 36.5° C.±0.5° C.

As shown in FIG. 16 and FIG. 17, the X axis operation stage 22X and the Y axis operation stage 22Y are set on the bottom of the box body 221. The X axis operation stage 22X and the Y axis operation stage 22Y are driven by a motor and a ball screw for example.

A small or band-shaped heater (not shown) is attached onto the Y axis operation stage 22Y. The heater is arranged in a position where the microplate 120 can be heated evenly.

The measurement area 226 and the non-measurement area 227 are divisions of the culturing stage 220 that are divided in the X direction by a top plate 228 and a pair of partition receivers 229 fixed to the box body 221. That is, in FIG. 16, the left region from the partition receivers 229 is the measurement area 226 and the right region therefrom is the non-measurement area 227.

Moreover, a partition plate 229a that is formed in a shape approximately matching with the cross-section of the box body 221, is attached onto the X axis operation stage 22X.

The partition plate 229a is arranged so that the inner space of the box body 221 is divided into two in the horizontal (X axis) direction, by moving the X axis operation stage 22X towards the non-measurement area 227 side to make the side faces on the opposite ends (ends in the Y direction) of the partition plate 229a contact with the partition receivers 229.

Furthermore, since the end on the top plate 228 side of the partition plate 229a is arranged so as to be in contact with the lower surface of the top plate 228, the measurement area 226 and the non-measurement area 227 can be made into two spaces that are separated from each other.

For the top opened region of the measurement area 226, a glass top cover 230 is detachably attached to the box body 221, and arranged so as to cover the top opened region of the measurement area 226. The method of attaching the glass top cover 230 includes for example, a method of fixing the glass top cover 230 onto the box body 221 with screws, and methods of attaching by a lock mechanism, catches, magnets and the like.

The glass top cover 230 may be made from a glass plate 231 for the whole surface or the approximate whole surface except for the surrounding frame parts, or may be the minimum area as long as it is within a range where the measurement is not impeded. For the glass plate 231, in order to suppress the light reflection during the transmission observation and the incident light observation, an optical glass material having anti-reflection films (AR coat) coated on both sides is preferably used.

The anti-reflection films may be coated on both sides of the glass plate 231 as described above, or anti-reflection film may be coated on one side of the glass plate 231.

The glass top cover 230 may be detached as necessary when performing various operations such as exchanging the object lens of the inverted type microscope 210, cleaning the inside of the measurement area 226, and the like.

An observation hole into which the object lens of the inverted type microscope 210 is inserted may be provided in the glass top cover 230. Moreover, a rubber sheet may be arranged in the observation hole so as to close the gap between the object lens and the observation hole. The sheet is desirably arranged so as not to obstruct the relative movement of the object lens and the culturing stage 220.

The openable and closable cover 222 is openably and closably attached to the top opened region of the non-measurement area 227 using a hinge or the like. In the state where the openable and closable cover 222 is closed, one end of the openable and closable cover 222 is in contact with the top plate 228 and supported.

The whole openable and closable cover is made from a material having a shading property (for example, the same material as the box body 221), and as necessary a peephole cover 232 which closes a peephole, and a UV irradiation hole cover 233 which closes a UV irradiation hole, are provided therein.

The peephole is an opening (window) formed in the openable and closable cover 222. The peephole cover 232 is formed from a glass plate or a resin plate having a low transmissivity, and fits into the peephole. Moreover, the peephole cover 232 may be formed from the same material as the openable and closable cover 222 having a shading property, and detachably and movably attached.

The UV irradiation hole is an opening (window) formed in the openable and closable cover 222. The UV irradiation hole cover 233 is formed from the same material as the openable and closable cover 222 having a shading property, and detachably and movably attached to the UV irradiation hole.

The UV irradiation hole cover 233 is detached when sterilization is performed by irradiating ultraviolet onto the inside of the non-measurement area 227. Moreover, a portable UV lamp may be used for the UV light irradiation.

The incubator box 100a storing the microplate 120 is held on the Y axis operation stage 22Y. Since the incubator box 100a is the same as that described in the first embodiment, the same reference symbols are used for the same components and the description thereof is omitted.

A culture gas is supplied from the culture gas supply connector 225 of the culturing stage 220 to the connector 123 of the incubator box 100a through a culture gas supply tube 234.

According to the above structure, since the inverted type microscope 210 is integrally provided in the biological sample observation system 200 according to the present invention, a biological sample can be observed using the inverted type microscope 210. Therefore, compared to the case where the inverted type microscope 210 is not provided, observation can be performed more precisely.

In order to keep the cells from being affected from the environmental light while the cells are being measured and cultured, the overall biological sample observation system 200 may be covered with a blackout curtain or the like.

The technical scope of the present invention is not limited to the above embodiments, and various modifications may be made without departing from the scope of the present invention.

For example, in the above embodiments, the description is for where the invention is suitable for a structure where the fluorescence intensity is detected. However, it is not limited to the structure where the fluorescence intensity is detected, but can be suitable for a structure where the morphological transformation of the cells and other various indexes are detected.

Moreover, it is not limited to the structure where the cells are observed, but can be suitable for the structure where bacteria, microorganisms, eggs, or various kinds of other biological samples are observed.

What is claimed is:

1. A biological sample observation system for observing change with time in a biological sample being cultured, comprising:
a culturing space where an inside environment is maintained at a predetermined level, and the biological sample is cultured under the environment;
a buffering space which is formed outside of the culturing space to relieve an effect on the culturing space, from the outside of the culturing space, and which is substantially separated from the outside; and
a detector which observes the biological sample inside the culturing space through at least a part of the buffering space.

2. A biological sample observation system according to claim 1, wherein the culturing space is maintained in an environment for culturing the biological sample.

3. A biological sample observation system according to claim 2, wherein the buffering space is maintained in an environment for culturing the biological sample, related to at least temperature.

4. A biological sample observation system according to claim 2, wherein the culturing space is maintained in an environment for culturing the biological sample, related to at least temperature.

5. A biological sample observation system according to claim 2, wherein the culturing space is maintained in an environment for culturing the biological sample, related to at least humidity.

6. A biological sample observation system according to claim 2, wherein the culturing space is maintained in an environment for culturing the biological sample, related to at least the concentration of culture gas contained in an atmosphere of the biological sample.

7. A biological sample observation system according to claim 6, wherein the culture gas contains carbon dioxide.

8. A biological sample observation system according to claim 2, wherein the culturing space is maintained in an environment for culturing the biological sample, related to at least the condition of a culture solution which is in direct contact with the biological sample.

9. A biological sample observation system according to claim 8, wherein the culturing space is maintained in an environment for culturing the biological sample, which is further related to the concentration of culture gas contained in an atmosphere of the biological sample during culturing of the biological sample, and the culture gas is dissolved in the culture solution.

10. A biological sample observation system according to claim 9, wherein the culture gas contains carbon dioxide.

11. A biological sample observation system according to claim 8, wherein the culturing space is an internal space of a culturing container for containing the biological sample, with the culture solution retained inside.

12. A biological sample observation system according to claim 11, further comprising a culture solution exchange section which exchanges the culture solution inside the culturing container space for a new culture solution.

13. A biological sample observation system according to claim 12, wherein the culture solution exchange section continually exchanges a specified quantity of the culture solution inside the culturing container during culturing of the biological sample.

14. A biological sample observation system according to claim 12, wherein the culture solution exchange section exchanges a specified quantity of the culture solution inside the culturing container for each predetermined timing, during culturing of the biological sample.

15. A biological sample observation system according to claim 14, wherein the culture solution exchange section appropriately updates the timing for exchanging the culture solution as required.

16. A biological sample observation system according to claim 15, wherein the culture solution exchange section determines the timing for exchanging the culture solution, based on data which stores characteristics of the biological sample being cultured.

17. A biological sample observation system according to claim 15, wherein the culture solution exchange section determines the timing for exchanging the culture solution, based on autofluorescent light from the culture solution.

18. A biological sample observation system according to claim 14, wherein the culture solution exchange section appropriately updates the quantity of culture solution to be exchanged as required.

19. A biological sample observation system according to claim 18, wherein the culture solution exchange section determines the quantity of culture solution to be exchanged, based on data table which stores characteristics of the biological sample being cultured.

20. A biological sample observation system according to claim 18, wherein the culture solution exchange section determines the quantity of culture solution to be exchanged, based on autofluorescent light from the culture solution.

21. A biological sample observation system according to claim 12, wherein the culture solution exchange section exchanges all of the culture solution inside the culturing container during culturing of the biological sample.

22. A biological sample observation system according to claim 21, wherein the culture solution exchange section exchanges all of the culture solution inside the culturing container for each predetermined timing, during culturing of the biological sample.

23. A biological sample observation system according to claim 1, wherein a second buffering space is formed further outside of the buffering space, and
the second buffering space relieves an effect of the environment on the buffering space and culturing space, from the outside of the second buffering space.

24. A biological sample observation system according to claim 23, wherein the culturing space is maintained in an environment for culturing the biological sample.

25. A biological sample observation system according to claim 24, wherein the second buffering space is maintained in an environment for culturing the biological sample, related to at least temperature.

26. A biological sample observation system according to claim 25, wherein the buffering space is maintained in an environment for culturing the biological sample, related to the concentration of culture gas used in culturing the biological sample.

27. A biological sample observation system according to claim 26, wherein the culture gas contains carbon dioxide.

28. A biological sample observation system according to claim 26, wherein inside the culturing space is maintained in an environment for culturing the biological sample, related to the condition of a culture solution which is in direct contact with the biological sample.

29. A biological sample observation system according to claim 1, comprising at least
a first zone which contains at least the culturing space, for culturing the biological sample in the interior of the culturing space, and
a second zone provided with the detection section,
and the first zone, and the second zone are partitioned from each other in a condition where the detection section can observe the biological sample.

30. A biological sample observation system according to claim 29, wherein at least temperature control is performed in the interior of the second zone.

31. A biological sample observation system according to claim 30, wherein a restraining section is further provided between the first zone and the second zone, for restraining air or temperature from passing between both zones.

32. A biological sample observation system according to claim 1, wherein the detection section is arranged on the outside of the buffering space, and includes an object lens which passes through the buffering space and is arranged on the inside of the buffering space.

33. A biological sample observation system according to claim 1, wherein the biological sample observation system is provided integral with a microscope.

34. A biological sample observation system according to claim 1, wherein the biological sample observation system is constructed so as to be detachable with respect to a microscope.

35. A biological sample observation system according to claim 1, wherein the biological sample being cultured includes a cell.

36. A biological sample observation method for observing a change with time in a biological sample being cultured, comprising:
a step for providing a culturing space where the inside environment is maintained at a predetermined level, and the biological sample is cultured under the environment;
a step for providing a buffering space which is formed outside of the culturing space to relieve the effect on the culturing space from the outside of the culturing space, and which is substantially separated from the outside;
a step for culturing the biological sample in the culturing space; and
a step for observing the biological sample inside the culturing space through at least a part of the buffering space, using a detector which observes the biological sample.
